(19) United States
(12) Patent Application Publication
(10) Pub. No.: US 2002/0138431 A1
(43) Pub. Date: Sep. 26, 2002

(54) System and method for providing supervision of a plurality of financial services terminals with a document driven interface

(76) Inventors: Thierry Antonin, Budapest (HU); Todd Shutts, Overland Park, KS (US)

Correspondence Address: Jennifer A. Albert, Esq., Hunton & Williams, Suite 1200, 1900 K Street, N.W., Washington, DC, 20006, US

(21) Appl. No.: 09/814,782

(22) Filed: Mar. 23, 2001

Related U.S. Application Data
(60) Provisional application No. 60/232,616, filed on Sep. 14, 2000.

(51) Int. Cl. G06F 17/60

(52) U.S. Cl. 705/42

(57) ABSTRACT

A system and method of providing a financial services terminal, such as an ATM, with a document driven interface. The system and method include a set of interface documents, such as HTML documents, that define an interface for the financial services terminal. The financial services terminal includes an interface application, such as a browser, for accessing the set of interface documents. A core application is associated with the financial services terminal and provides various functions for overseeing transactions executed through the financial services terminal, such as transaction processing, control of financial devices, and communications with a financial data network. A supervisor application is provided for overseeing operation of multiple financial services terminals from a remote location.

This application is a conversion of the U.S. provisional application serial number 60/232,616, entitled “WEB-ENABLED AUTOMATED TELLER MACHINE” filed on Sep. 14, 2000.

### BACKGROUND OF THE INVENTION

The invention relates to the field of financial service terminals and related backend systems.

Automatic teller machines (ATMs), and other financial services terminals, have been part of the financial services landscape for some time. ATMs typically include one or more display devices, such as a cathode ray tube, speakers, lights, or other display devices. The display devices provide information and stimulus for attracting ATM users and providing interactive financial services. ATMs often incorporate a printer, such as a receipt printer, for providing hardcopy output to users. ATMs commonly include one or more input devices. Most typically, the input devices are limited to a number pad, a limited number of flnction buttons, or, in some cases, a touch screen. Some ATMs have incorporated a trackball or other pointer technology or a more substantial keyboard as input devices. ATMs generally include one or more security related input devices, most commonly, a card reader. Common card readers may include swipe, capture, insert and remove, smart chip, and other card readers. Some ATMs incorporate additional security input devices, such as cameras and other image capture devices, biometric sensors (e.g., fingerprint readers, retinal scanners, voice analyzers, etc.), motion detectors, pressure plates, and other security devices. Most ATMs incorporate one or more financial devices for enabling financial transactions. Common financial devices include sheet dispensers, depositories, hardware encryptors, secure memory devices, and other financial devices.

The core of an ATM includes a microprocessor, one or more memory systems, and one or more communication devices for exchanging information with one or more financial data networks. The financial data networks frequently include access to a host financial system, such as that of the sponsoring bank or other financial institution, and a switched financial network for accessing a number of other financial systems, such as other banks, credit card companies, and other financial institutions. The location and capabilities of ATM software varies. Some ATMs include local system, communications, security, interface, and transaction processing software. Some ATMs are thin clients in a client/server architecture. These ATMs may include minimal system, security, and communication software locally and rely upon server side applications for additional system, communications, security, interface, and transaction processing software.

The financial transactions offered through most ATMs are fairly limited. A combination of limited input and output devices, limited memory and processor capabilities, application development time, inconsistencies in hardware and software platforms, limited information available through financial data networks, concerns over transaction times and customer flow, and other factors have limited the number and types of transactions offered through ATMs. A typical ATM may enable a small number of financial transactions, such as withdrawals, balance inquiries, and intra-institution account transfers for one or more accounts, usually including foreign accounts through financial institutions available over a financial data network. Withdrawals may include transactions for set withdrawal amounts from a predefined account (so-called “Fast Cash” transactions), as well as transactions for a withdrawal amount and account input by the user. These limited transactions are available through most financial data networks. Many ATMs may offer additional transactions for ATM users that are customers of the host financial institution. For example, additional account information, deposits, and product information may be available to such ATM users. These additional transactions may be enabled by a custom interface module between the ATM and the host financial institution's accounting system or financial data management system. ATM customers and financial institutions looking to distinguish their services from those of their competitors have sought additional transactions and services that can be offered through ATMs.

One solution for adding additional transactions has been through custom interface modules between a host financial institutions ATM network and a third party service provider system. The use of third party service provider systems has been limited due to the difficulty of negotiating access between systems, providing custom applications for accessing transactions through the third party service provider, and maintaining the security of both the financial systems and the service provider systems. One example of such an application would be the sale of performance tickets through ATMs. ATM specific transaction protocols would be defined for accessing a ticket data source to locate a desired ticket, accessing the ticket provider accounting system for executing the purchase transaction, and accessing the financial system or a financial data network for settling payment for the ticket. ATM specific transaction protocols may also have to be defined for fulfillment of the ticket purchase, such as by printing the ticket at the ATM, but fulfillment may be handled by the ticket provider accounting system, such as through mail or a will call window.

A second solution for adding additional transactions has been through transaction systems associated with the switches of the financial data networks. Switch operators are uniquely positioned for enabling additional services through ATMs attached to their financial data network. The switch operators may define routing information and transaction parameters for one or more additional transactions outside of the standard financial transactions. A transaction system for handling the additional transaction may be provided by the switch operator, such that transaction requests for the additional transactions are routed to the transaction system for handling. The transaction system may provide transaction processing and may access one or more remote transaction systems for fulfilling the transaction request. ATM specific interface protocols may still need to be defined for accessing the additional transactions. For example, a switch operator may provide a bill pay transaction through ATMs connected to its network. The switch operator may define a bill pay transaction with a standard format and protocol for receiving the information for processing the transaction, such as biller identification, payment amount, and payment information. The standard format may include routing information for directing the transaction to the switch operator's transaction system. The switch operator's transaction system may provide the logic for processing the request. The switch operator may negotiate access to the accounting systems of a number of billers who's bills may be paid through the ATMs. Added transactions through third party systems or switch transaction systems have not fully addressed the input, output, transaction time, and other limitations imposed by existing ATM interfaces or software and hardware platforms.

Hypertext Markup Language (HTML) and TCP/IP have been applied to improve the quality, interoperability, and content of ATM interfaces and communications. HTML provides a more manageable and customizable solution for creating and customizing ATM interfaces. ATMs have traditionally operated through a small number of “screens” defining their interface. These screens are easily replaced by a series of HTML documents. HTML technology allows easy introduction of more robust content. Increases in processor speeds and the affordability of computer hardware and memory have made delivery of interfaces including more graphics, sound, and even animation practical. Further, the modular nature of HTML documents and the capability to dynamically generate HTML documents have made improved aesthetics and customization of content very practical. HTML interfaces may be implemented through a client/server architecture with little more than a browser application present in the ATM itself. Centralization of ATM interface information in a client/server architecture provides advantages in maintaining the ATM interfaces across a number of ATMs. This is particularly important as financial institutions continue to evolve the transaction sets they wish to implement through their ATMs. TCP/IP provides a ubiquitous communication standard for exchanging information efficiently among disparate networks. HTML and TCP/IP have coincided with the widespread implementation of platform independent programming languages, such as Sun Microsystem's Java™ programming language. These tools have fueled a push towards platform independent, server based ATM networks for implementing traditional ATM financial transactions. Suggestions have been made that all financial systems could be converted to interoperable, platform independent, HTML, TCP/IP network resources for implementing financial transactions. However, the use of ubiquitous standards, such as HTML and TCP/IP, has raised many security concerns. Further, a great deal has already been invested in ATM hardware, host financial systems, switched financial data networks, and other systems for quick and economically sound adoption of new standards. Further refinements in HTML, as well as eXtensible Markup Langage (XML), implementations for ATMs are still necessary for widespread adoption of the technology. Harmonization with pre-existing financial systems may be particularly important.

Advances in computing power, communication speeds, standardized communication protocols, and widespread electronic document systems and document handling protocols have provided enabling technologies for more robust ATMs. Many of these advances have been developed for or implemented through the Internet. The Internet has spawned rapid advancement in user oriented transaction systems. These transaction systems are generally accessible to customer users from user devices, such as personal computers, WAP and SMS enabled portable devices, and other devices. Financial institutions, billing services, brokerages, merchants, and other service providers of all kinds have expended considerable resources on developing transaction systems implementing a wide variety of transactional functions. Content delivery, customer service systems, electronic transactions, communications, access to data libraries and accounting systems, and many other flnctions have been implemented using Internet protocols. For example, many financial institutions have implemented interface systems and transaction systems that interact with their electronic systems and data libraries to provide most types of banking transactions, such as detailed account access, product information and transactions (e.g., loan application and approval), and customer service. Various biller companies, most commonly utilities, telecommunication companies, subscription services, credit card companies, and others, have implemented interface systems that interface with their electronic systems and data libraries. These systems offer a variety of account access, bill payment and customer service transactions. The brokerage industry has been greatly changed by the availability of the Internet for instant information delivery and transactional abilities. Brokerages have implemented interface systems and transaction systems that interface with their systems and data libraries for providing up-to-the-minute financial information and trading transactions. Merchants have implemented interface systems and transactions systems for providing access to vast product information and all manner of purchase transactions. Other service providers have developed a variety of interface and transaction systems for delivery of content, such as weather, news, entertainment, educational content, topical information, directories, and other information. An important aspect of many of these financial, merchant, and other systems has been offering customization for individual customers. The electronic systems for implementing a vast array of transactions has already been built and will continue to be developed to support and increasingly Internet oriented customer base. These electronic systems provide a fertile ground for providing enhanced services through ATMs. However, ATM systems and methods have not yet been developed to adequately integrate transactional abilities from these pre-existing systems through ATM networks.

These and other drawbacks exist in current ATMs, other financial services terminals, and associated backend systems.

### BRIEF SUMMARY OF THE INVENTION

The invention includes systems and methods for providing enhanced services, such as added financial, information, transaction, and communication services, through financial service terminals, such as automatic teller machines. The systems and methods may include a system for supervising a plurality of remote financial services terminals; a method of providing supervision of a plurality of financial services terminals; a system for providing remote aggregation of data from a plurality of financial services terminals; a system for providing local administration of a plurality of financial services terminals; a system for supervising a plurality of financial services terminals including an interface application; and a method of customizing a plurality of interface documents for use by a plurality of financial services terminals.

One aspect of the invention is a system for supervising a plurality of remote financial services terminals. The system includes an interface application, a core application, and a supervisor application. The interface application is located within each of the remote financial service terminals for displaying interface documents with components for accessing financial transactions. The core application is in communication with the interface application. The core application oversees processing of financial transactions accessed through the components in the interface documents. The supervisor application is in communication with the core application. The supervisor application performs administrative functions for overseeing the operation of the remote financial service terminals.

Another aspect of the invention is a method of providing supervision of a plurality of financial services terminals. The method includes providing financial services terminals in locations remote from a supervisor application. The financial services terminals include an interface application for displaying interface documents. The method also includes providing a core application in communication with the financial services terminals. The core application includes modules for overseeing operation of the financial services terminals. The method also includes communicating a method call from the supervisor application to the core application. The method also includes initiating at least one of the modules for an administrative function in response to the method call communicated from the supervisor application. The method also includes receiving a method response from the core application in the supervisor application.

Still another aspect of the invention is a system for providing remote aggregation of data from a plurality of financial services terminals. The system includes interface documents, at least one component, and a remote aggregation module. The interface documents are accessible to the financial services terminals for displaying an interface for financial transactions. The component listens for at least one event at the financial services terminals. The remote metric aggregation module receives and stores usage data from the financial services terminals in response to the occurrence of the at least one event at the financial services terminals.

Yet another aspect of the invention is a system for providing local administration of a plurality of financial services terminals. The system includes consumer interface documents, supervisor interface documents, and a remote supervisor application. The consumer interface documents display an interface for financial transactions through financial services terminals. The supervisor interface documents display an interface for administrative functions through the financial services terminals. The remote supervisor application is in communication with the financial services terminals. The remote supervisor application monitors access to the administrative functions.

Another aspect of the invention is a system for supervising a plurality of financial services terminals including an interface application. The system includes interface documents, an object library, and a supervisor application. The interface documents are accessible to the financial services terminals for providing an interface for financial transactions through the interface application. The object library is accessible to the financial services terminals. The object library includes objects associated with the interface documents for providing content and functionality to the interface documents. The supervisor application is associated with the object library and the interface documents for managing the object library and the interface documents.

Another aspect of the invention is a method of customizing a plurality of interface documents for use by a plurality of financial services terminals. The method includes selecting an interface document template from an object library to initiate creation of a custom interface document. The method also includes selecting at least one director from the object library and adding the selected director to the custom interface document for defining a relationship to at least one other interface document. The method also includes selecting at least one component from the object library and adding the selected component to the custom interface document for defining access to at least a portion of a financial transaction.

### BRIEF DESCRIPTION OF THE DRAWINGS

FIG. 1 is a schematic view of an example system including a plurality of financial services terminals and associated backend systems according to an embodiment of the invention.

FIG. 2 is a schematic diagram of an example software system for providing financial transactions through a plurality of financial service terminals according to an embodiment of the invention.

FIG. 3 is a schematic diagram of example hardware and software for a plurality of financial services terminals and an associated server system according to an embodiment of the invention.

FIG. 4 is a flow chart of an example method of preparing a plurality of financial services terminals according to an embodiment of the invention.

FIG. 5 is a flow chart of an example method of defining a terminal configuration according to an embodiment of the invention.

FIG. 6 is a flow chart of an example method of configuring a terminal according to an embodiment of the invention.

FIG. 7 is a flow chart of an example method of defining a terminal interface document according to an embodiment of the invention.

FIG. 8 is a schematic view of a plurality of supervisor applications for use in association with a plurality of financial service terminals according to an embodiment of the invention.

FIG. 9 is a schematic view of an example security system for a plurality of financial services terminals according to an embodiment of the invention.

FIG. 10 is a flow chart of an example method of providing secure financial transactions through a plurality of financial services terminals according to an embodiment of the invention.

FIG. 11 is a schematic view of an example system for integrating a transaction system with a plurality of financial services terminals according to an embodiment of the invention.

FIG. 12 is a flow chart of an example method of integrating a transaction system with a plurality of financial services terminals according to an embodiment of the invention.

FIG. 13 is a flow chart of an example method of defining a static content component according to an embodiment of the invention.

FIG. 14 is a flow chart of an example method of defining a dynamic content component according to an embodiment of the invention.

FIG. 15 is a flow chart of an example method of defining a transaction component according to an embodiment of the invention.

FIG. 16 is a flow chart of an example method of identifying transaction requirements for a transaction object according to an embodiment of the invention.

FIG. 17 is a schematic view of an example system for integrating a electronic commerce system with a plurality of financial services terminals according to an embodiment of the invention.

FIG. 18 is a schematic view of an example system for integrating a financial system with a plurality of financial services terminals according to an embodiment of the invention.

### DETAILED DESCRIPTION OF THE INVENTION

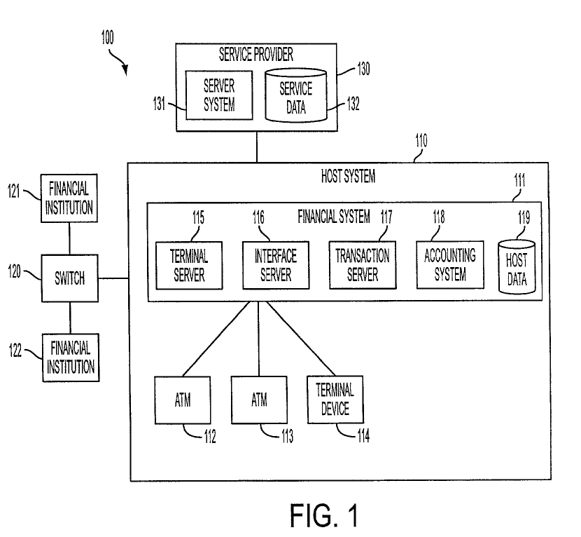

FIG. 1 shows an example system 100 for providing enhanced financial services through a number of financial services terminals. The system 100 includes several other systems within it. The system 100 includes a host system 110. Host system 110 includes the core architecture for providing financial services through financial services terminals. Host system 110 includes a financial system 111 for a financial institution associated with the host system and a number of terminal systems, a first ATM 112, a second ATM 113, and a terminal device 114. The financial system 111 enables access to account information and a variety of transactional services related to accounts and services provided by the host financial institution. The terminal systems provide customer access points, remote or local to a host bank location, for accessing financial services. The system 100 includes a switch system 120. The switch system 120 provides access to a financial data network by providing routing of transactions meeting predefined security measures, formats, and protocols. The switch system 120 provides access to a number of financial institution systems 121 and 122. The financial institution systems 121 and 122 provide access to account information and transactions involving accounts at financial institutions associated with the financial institution systems. The system 100 includes a service provider system 130. The service provider system 130 provides access to additional transactions and may include a wide variety of service and transaction types The host system 110, the switch system 120, the financial institution systems 121 and 122, and the service provider system 130 may be interconnected by a number of different network and communication channels and protocols. For example, the host system 110 may communicate with switch system 120 using a standard communication protocol or a proprietary communication protocol selected by the operator of the switch system 120. The host system 110 may communicate with the service provider system 130 using Internet communication standards, such as TCP/IP and HTML. Communications between the host system 110 and the switch system 120, the host system 110 and the service provider system 130, and communications within the host system 110, the switch system 120, and the service provider system 130 may be encrypted according to one or more encryption standards for increased security.

The host financial system 111 includes several components of a financial system, including a terminal server 115, an interface server 116, a transaction server 117, an accounting system 118, and a host data source 119. In an alternate embodiment, the host system 110 may include a plurality of financial systems. Each financial system may include a variety of server functions, functional systems, and data sources beyond those depicted in FIG. 1. In an alternate embodiment, one or more portions of the financial system or systems may be located in a service provider system outside the host system 110, similar to service provider system 130. Such an external financial system or or portions of a financial system may communicate with the host system 110, including the first ATM 112, the second ATM 113, and the terminal device 114 through one or more communication channels. For example, the first ATM 112, the second ATM 113, and the terminal device 114 may communicate with an outside interface server using Internet protocols.

The terminal server 115 may be any terminal server system for providing centralized resources for the operation of a number of financial services terminals. In a preferred embodiment, the terminal server 115 is a server for providing a number of interface documents and remote applications to the ATMs 112 and 113 and the terminal device 114. For example, the terminal server 115 may be a Windows NT™ Server running one or more software application for managing a plurality of HTML documents and applications for simultaneous access from a plurality of remote client interface applications. The terminal server 115 may also include communication channels for exchanging data with a number of other resources for fulfilling transactions through its client financial services terminals. In one embodiment, terminal server 115 includes at least one communication channel for accessing financial information and services within other portions of the financial system 111. The terminal server 115 may include one or more applications for dynamically generating content, such as XML and HTML documents or portions of documents, for access by client financial services terminals, such as ATMs 112 and 113 and terminal device 114. The terminal server 115 may include one or more communication channels for exchanging data with the interface server 116 by accessing a plurality of interface documents associated with the interface server 116. The terminal server 115 may include one or more communication channels for exchanging data with the transaction server 117 by directly accessing a transaction management application. In alternate configurations, the terminal server 115 may directly access the accounting system 118 or the financial data source 119. In an alternate configuration, the terminal server 115 may access one or more financial systems outside the host system 110, similar to the service provider system 130.

The other portions of the financial system 111, including the interface server 116, the transaction server 117, the accounting system 118, and the host data source 119, may provide a variety of services and functions for the host financial institution. The interface server 116 supports one or more interface systems for offering information and transactions to customers through one or more user devices or other access points. In a preferred embodiment, the interface server 116 may be a Web server providing access to a host financial institution customer Web site over the Internet. The interface server 116 may also support access through wireless devices and protocols or other information networks. In an alternate embodiment, the interface server 116 is a telephone server supporting a telephone banking application for the host financial institution. The interface server 116 may provide access to the transaction processing capabilities of the transaction server 117.

The transaction server 117 provides backend processing for a variety of customer oriented services, such as services provided through the financial institution's Web site, telephone banking system, and other access points. The transaction server 117 may provide the processing logic for data query, deposit, withdrawal, transfer, debit, credit, new account, customer service access, and other transactions. The transaction server 117 may be accessed by a number of interface systems, such as the interface server 116. The transaction server 115 may provide an access point for direct data exchange with the host financial institution systems, such as the accounting system 118 and the host data source 118. In an alternate embodiment, the transaction server 115 may also provide an access point for other remote financial systems, such as one or more financial data networks to which the host financial institution belongs.

The accounting system 118 provides backend financial transaction processing, account management, data management, and other functions for the host financial institution. The accounting system 118 may include some or all of the data processing logic for the internal systems of the host financial institution. The accounting system 118 may include one or more access applications for various personnel employed by the host financial institution. The accounting system 118 may include a combination of data management, data access, and data processing applications for managing the host financial institutions core data, such as customer information, customer accounts, financial institution holdings, administrative data, and other critical data. Some or all of the functions of the accounting system 118 may be supported by are provide access to the data contained in the host data source 119.

The host data source 119 includes one or more data sources supporting the operations of the host financial institution. The host data source 119 may include one or more data libraries containing a variety of financial institution data, such as transaction data, interface data, customer data, account data, general financial data, transaction data, financial product data, financial institution holdings data, administrative data, and other data. The host data source 119 may be embodied in one or more databases and associated database management systems.

The ATMs 112 and 113 and the terminal device 114, also referred to as the financial services terminals, represent a number of remote terminal devices for accessing the interface documents and remote applications of the terminal server 115. The ATMs 112 and 113 and the terminal device 114 may each include a number of input, output, and financial devices, as well as system and application software. In a preferred embodiment, the ATMs 112 and 113 and the terminal device 114 may each have different configurations of input, output, and financial devices. The ATMs 112 and 113 and the terminal device 114 may each include different system and application software. The ATMs 112 and 113 and the terminal Device 114 may each provide different functions, operate on varying schedules, or otherwise provide divergent services. For example, the first ATM 112 may be a full service financial services terminal available at one of the host financial institutions branches, the second ATM 113 may be a small, high security terminal for placement in less secure remote locations, such as gas stations, convenience stores, and retail establishments, and the terminal device 114 may be a financial services kiosk without financial devices for placement in a shopping mall, grocery store, bank branch lobby, or other high traffic area. The terminal server 115 may provide a variety of interface documents and remote applications for supporting the divergent functions of its client terminal devices, such as the ATMs 112 and 113 and the terminal device 114. In a preferred embodiment, the ATMs 112 and 113 and the terminal device 114 include an interface application for displaying interface documents and a core application for overseeing the operation and transactional functions of the financial services terminals. Also in a preferred embodiment, the interface application and the core application may run on separate virtual machines within the same financial services terminals. In an alternate embodiment, where network and processing speeds warrant, the core application may be hosted remotely, such as with the terminal server 115.

The switch system 120 and the financial institution systems 121 and 122 may represent example components in any of a number of financial data networks. Financial data networks are networks for enabling the exchange of secure financial data among a plurality of financial institutions and other financial service providers. The switch system 120 may provide a predefined security standard, data format, and communication protocol for accessing financial transactions through a plurality of financial institutions. For example, the switch system 120 may define an encryption standard, such as DES encrypted PIN blocks, for sensitive information, such as account numbers, personal identification numbers (PINs), transaction codes, and other data. The switch system 120 may define a particular format for submitting transaction requests, describing the placement and content of account information, PINs, transaction amount, transaction type, transaction tracking information, and other information. The switch system 120 may define a particular communication protocol, including security information and routing information, for each transaction. The switch system 120 may also define a security standard, data format, and communication protocol for returning responses to the transaction requests submitted to it. Any given switch system, such as the switch system 120, may define a small number of transaction types which they handle, such as inquiries, withdrawals, transfers, debits, credits, and other transaction types. The switch system 120 may include transaction processing logic or access to other service providers for supporting additional transaction types, such as bill payment. In an alternate embodiment (not shown in FIG. 1), the host system 110 may be connected to multiple switch systems for access to multiple financial data networks.

The service provider system 130 includes a server system 131 and a service data source 132. The service provider system 130 may represent any number of electronically enabled systems for providing consumer oriented services. Some example service providers may include financial institutions, merchants, biller companies, information service providers, content delivery service providers, and many others. In a preferred embodiment, the service provider system 130 provides transactional services to consumers over the Internet. The service provider system 130 may include a variety of systems and data sources for enabling consumer oriented services. As shown, the service provider system 130 includes a server system 131 and a service data source 132. The service provider system 130 may include transaction systems, accounting systems, customer service systems, interface systems, and other systems for supporting a variety of consumer oriented services. The service provider system 130 may include transaction data, account data, product data, customer data, interface data, topical data, or other data. The service provider system 130 may provide aggregate or individual access to information, functions, or transactions provided by other third party service providers. The host system 110 may communicate with a plurality of service provider systems for simultaneously enabling a variety of divergent functions.

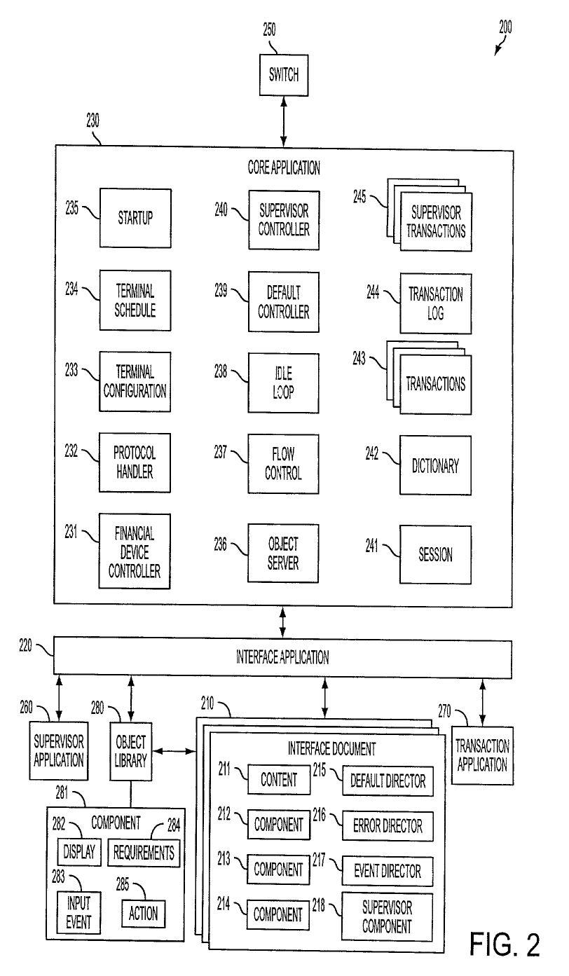

FIGS. 2-18 show a variety of systems and methods that may be enabled through a system such as System 100 in FIG. 1. The systems and methods shown in FIGS. 2-18 may all be simultaneously incorporated within a system such as system 100. However, each of the systems and methods shown and described may also be embodied or enabled by many other system configurations. Many of the alternate configurations include only a portion of the components shown for system 100 in FIG. 1. Also, the components shown in FIG. 1 are depicted in a highly generalized state. Many of the details shown are fragmentary and incomplete. The details of example components for system 100 are more completely shown and explained with regard to FIGS. 2-18.

The features of the systems shown in FIGS. 2-3, 8-9, 11, and 17-18 are depicted as functional modules for simplicity of explanation. The functional modules may each contain a combination of software and/or hardware for performing a task or a set of tasks. For example, a data processor, a memory, and an instruction set (i.e., computer programming code) may be all that are needed for such a functional module to carry out the tasks necessary for a given embodiment of each functional module. More commonly, however, multiple input and output devices, a plurality of short term and long term memory systems, a plurality of layers of computer code (i.e., operating system, application software, etc.), a plurality of communication devices, and multiple processors may be used for each such functional module. Additionally, multiple ones of such functional modules may share the same hardware and portions of a software library. In some cases, a functional module may contain one or more other such functional modules. As will be understood by those of ordinary skill in the art, the functional modules described herein may be embodied in a large number of equivalent combinations of code objects and hardware. The combinations represented by the functional modules described herein are conceptual and should not be construed as a limiting structure for the multiple hardware and software combinations capable of executing the functional module's tasks.

FIG. 2 shows an example system for providing financial transactions through a plurality of financial service terminals. A plurality of interface documents 210 provide data for defining the interface and transactions available through the plurality of financial service terminals. A object library 280 may provide a plurality of applets accessible though or otherwise associated with the interface documents 210 for providing some portion of transaction processing and interface logic. The interface documents 210 are presented through an interface application 220. The interface application 220 is located in each of the financial services terminals. The interface application 220 uses data provided in the interface documents 210, including applets from the object library 280, to access a core application 230. The core application 230 provides operation oversight and a portion of transaction processing for transactions initiated by the interface application 220. The core application 230 may, in turn, utilize a switch system 250 for some portion of the transaction processing. A supervisor application 260 may provide supervisory access to a number of financial service terminals or data associated with the financial services terminals. Supervisor application 260 may be a recipient of information from interface application 220 or may actively communicate with interface application 220 to engage core application 230. A transaction application 270 may provide additional transaction processing or transaction data to interface application 220. FIG. 2 also shows details of an example component 281, such as might be found in object library 280 or embedded in interface documents 210.

The interface documents 210 include a variety of embedded objects for providing interface data to the interface application 220 and accessing the core application 230. The interface documents 210 include content 211 for presenting screens and other output for guiding a user through the financial transactions. The interface documents 210 also includes a number of components 212, 213, and 214 for initiating processing of the financial transactions. The interface documents 210 also include a number of directors, such as a default director 215, an error director 216, and an event director 217, for defining relationships among the various documents in the interface documents 210. The interface documents 210 also include a supervisor component 218 for providing supervisory monitoring the financial services terminal. In a preferred embodiment, Interface Documents 210 are a plurality of HTML or XML documents. The HTML documents may include embedded applets in a platform independent programming language, such as Sun Microsystem's Java™ programming language. A set of interface documents may define multiple screens in an interface. A set of interface documents may completely define the interface for a given financial services terminal and all of its functions. In one embodiment, different sets of interface documents may be provided for different ATMs or other terminal devices. Different sets of interface documents may also be provided for the same financial services terminal at varying times. In one embodiment, the interface documents 210 are dynamically generated at runtime based upon one or more types of variable content or functions. One or more objects in the interface documents 210 may be stored in the object library 280. Objects stored in the object library 280 may be accessed directly by the interface documents 210. Objects store in the object library 280 may be accessed by interface application 220 based upon references from the interface documents 210.

The content 211 may include page formatting, text, graphics, sound, and other aesthetic and informational features displayed on or associated with a particular screen. The content 211 may be distinguished from the components 212, 213, 214, the directors 215, 216, and 217, and the supervisor component 218 based upon the content 211's lack of transactional function or relationship to other interface documents. The content 211 includes basic formatting and objects that are mere interface data without listener or event-based logic attached to them. The content 211 may defined directly within the interface document 220 itself or may be accessed through an embedded object, such as a graphics file or other object. Some or all of the content 211 may be dynamically generated at runtime. For example, a content object may include a reference to a file location with variable content maintained by one or more content management applications. As another example, a content object may be defined as a template or style sheet for accessing one or more data sources through a data management application. Content 211 may be distributed in a plurality of content objects for easy manipulation, customization, and generation of new interface documents. In one embodiment, content objects may access content data through one or more other applications, such as the core application 230, the switch system 250, the supervisor application 260, or the transaction application 270. However, in many cases, it is preferable to use one or more components and directors for accessing data in other applications to enable monitoring and error handling for data calls outside the data source or sources providing the interface documents 210 or the object library 280.

The components 212, 213, and 214 are function oriented objects embedded in the interface documents 210. In a preferred embodiment, the components 212, 213, and 214 are Java™ beans embedded in applets and related to one or more modules within the core application 230. The components 212, 213, and 214 may include instructions for raising an event to the core application 230 and a triggering terminal event. The components 212, 213, and 214 monitor events at the financial services terminal and react to events meeting the requirements defined in their triggering event. The components 212, 213, and 214 may each monitor different or overlapping events. For example, each of the components 212, 213, and 214 may be associated with the actuation of a function key, a number from a key pad, or an area of the touch screen as a triggering event. In one embodiment, the components 212, 213, and 214 may initiate or monitor any device in the financial services terminal for a triggering event. The components 212, 213, and 214 may react to the triggering event by passing data received at the terminal to one or more modules in the core application 230. For example, card data input from swiping a customer card through a terminal's card reader may be passed to an appropriate buffer in the core application 230. Any one of the components 212, 213, and 214 may include a call to a transaction module within the core application 230 for initiating further processing by the core application 230. The components 212, 213, and 214 may also raise an event for triggering a director, such as one of the directors 215, 216, and 217. The components 212, 213, and 214 may include a property defining content associated with actuation of the triggering event. For example, the components 212, 213, and 214 may include graphics (e.g., buttons) that correspond to touch screen locations, function keys, or a number based menu. Content properties for the components 212, 213, and 214 may also include audio cues or other content data associated with them. The components 212, 213, and 214 may include some built in logic. In one embodiment, the components 212, 213, and 214 may include logic for exchanging data with one or more applications other than the core application, such as the supervisor application 260 or the transaction application 270. The components 212, 213, and 214 may also include logic for monitoring the data exchange, reporting the data exchange to the core application 230, and providing retrieved data for use by other components, directors, or content objects. Some example components may include a PIN entry component, a language definition component, a transaction definition component, an amount available component, a text input component, an amount definition component, a customer profile request component, an authorization component, a card inserted component, a card eject component, a card capture component, a card read component, a smart card read component, a cash access component, a cash presentation component, a cash retract component, an in service component, and a read variable component. Additional description relevant to the components 212, 213, and 214 is provided below with regard to the example component 218.

The directors 215, 216, and 217 are objects that monitor terminal events for one interface document in order to provide the instructions or link to the next interface document. The directors 215, 216, and 217 each have a triggering event and a destination interface document associated with them. The directors 215, 216, and 217 may not have any display effect for the financial services terminal. A director may wait for a clock-based timeout event, wait for a single terminal event to be raised, or wait for multiple terminal events to occur. The directors 215, 216, and 217 may await an event raised by one or more of components, such as the components 212, 213, and 214 or supervisor component 218. In a preferred embodiment, the default director 215 monitors for a timeout event the default director 215 may provide instructions to a default or timeout interface document. In a preferred embodiment, the error director 216 monitors for an input error event or a processing error event. The error director 216 may provide instructions to an input error or processing error interface document. In a preferred embodiment, the event director 217 monitors for an input or communication event meeting a desired condition for the interface document. In one embodiment, a plurality of event directors may be defined corresponding to a plurality of components. Each component may raise an event for a different director and load a different next interface document. For example, an interface document may be defined to include a menu of transactions available through an ATM. The interface document may include a plurality of components, such as components 212, 213, and 214, that correspond to the transactions available and are represented graphically by entries in a menu in the interface document. There may be an event director corresponding to each of the components for loading a new interface document for the selected transaction. There may be an error director for providing a next interface in the event that the user makes a selection not available from the menu. There may be a default director for loading a new interface document in the event that a set amount of time passes without an entry from the user. In a preferred embodiment, directors (and corresponding next interfaces) may be defined with general purposes such that multiple transactions may use a director to the same destination. For example, many transactions may require PIN entry or selection of a transaction amount. Some example directors may include an idle director, an amount selection director, a PIN entry director, and a synchronization director.

The supervisor component 218 may provide one or more of several supervisor functions. In one embodiment, the supervisor component 218 is a listener that monitors terminal events and transactions for reporting those events to a supervisor transaction within the core application 230 and/or the supervisor application 260. For example, the supervisor component 218 may be a listener that monitors for user selection of a transaction. When the transaction is selected, the selection, time, and possibly other user or transaction information may be sent to a remote supervisor application for aggregating use metrics for the ATM. In one embodiment, the supervisor component 218 may monitor for local supervisor input for switching to a local supervisor mode. For example, the supervisor component 218 may listen for a mechanical input, such as a key driven switch, for accessing the supervisor mode. The supervisor component 218 may monitor for other input, such as supervisor PIN, a supervisor card, or other input. The supervisor component may report the local triggering event to a security log for the terminal or the supervisor application 260. The supervisor component 218 may raise the event to an event director for initiating one or more interface documents offering supervisor transactions or an interface for the supervisor application 260. For example, the supervisor component 218 may initiate a series of interfaces to allow a technician to see to local maintenance, such as accessing the depository, refilling the cash dispenser, or running diagnostics on one or more systems.

The interface application 220 may be any application for accessing the interface documents 210 and implementing the objects contained in the interface documents 210. The interface application 220 is resident on each financial services terminal. The interface application 220 may be any application for rendering interface documents in a financial services terminal. The interface application 220 supports access to the core application 230 through embedded applets within the interface documents 210. The interface application 220 supports communications with one or more server systems, such as a server system hosting the interface documents 210 and the object library 280, a server system hosting the supervisor application 260, or a server system hosting the transaction application 270. In a preferred embodiment, the core application 230 is located on a virtual machine and accessed by the interface application 220 using remote communication protocols. In one embodiment, at least a portion of the virtual machine is within the same hardware as the interface application 220. The interface application 220 may support one or more protocols for communicating with remote server systems and executing applets embedded in the interface documents 210. The interface application 220 supports presentation of data through a variety of output devices, such as a CRT display, speakers, and other output devices. The interface application 220 may support access to a printer device, such as a receipt printer. The interface application 220 may support one or more encryption standards for data transfer. The interface application 220 may support certificate verification for digital certificates associated with interface documents, applets, and other files and modules the interface application 220 handles. The interface application 220 may include a plurality of configuration settings. For example, configuration settings may allow filters to be placed on the types, locations, or identity of interface documents that may be accessed by the interface application 220. Configuration settings may define the communication devices that may be accessed by the interface application 220. Configuration settings may define the encryption standards and other security settings of the interface application 220. Configuration settings may define the types, parameters, or identities of plug-in technology or applets supported by the interface application 220. In a preferred embodiment, the interface application 220 is a browser. For example, the interface application 220 may be Netscape Navigator™ or Microsoft Explorer™. The browser may be configured to support a variety of security measures for limiting undesirable uses of the browser, while supporting the familiar platform for interface design and implementation.

The core application 230 includes a number of modules for handling various portions of transaction processing and financial services terminal oversight. The core application 230 provides at least a portion of the backend processing in support of the interface documents 210 and associated components. The core application 230 may provide communications with and transaction formatting and handling for transactions with one or more remote systems, such as the switch system 250. The core application 230 may also provide transaction logs, error handling, or other monitoring for the supervisor application 260 and the transaction application 270. The core application 230 may oversee operation of one or more secure resources in the financial services terminals, including devices that may not be accessed directly by the interface application 220. In a preferred embodiment, the core application 230 is located on a secure virtual machine and communicates with the interface application 220 through a remote method invocation (RMI) protocol, such as Java™ RMI. The core application 230 may or may not be local to the interface application 230. The virtual machine provides additional security layers for accessing the functions of the core application 230. The virtual machine allows the same core application to be provided on any hardware supporting the virtual machine. The virtual machine may also provide a platform for providing access to one or more devices in the financial services terminal from the core application 230, while rendering them inaccessible to the interface application 220 or other applications outside the virtual machine supporting the core application 230. In the example embodiment shown in FIG. 2, the core application 230 includes a financial device controller 231, a protocol handler 232, a terminal configuration 233, an terminal schedule 234, a startup module 235, an object server 236, a flow control module 237, an idle loop module 238, a default controller 239, a supervisor controller 240, a session module 241, a dictionary module 242, a plurality of transactions 243, a transaction log 244, and a plurality of supervisor transactions 245.

The financial device controller 231 is a control module for interfacing with one or more financial devices in a financial services terminal. In one embodiment, the financial device controller 231 may be associated with at least one secure communication channel for issuing instructions to remote financial devices and receiving responses from the remote financial device. The financial device controller 231 is compatible with the financial device drivers installed in the financial services terminal for operating the financial devices. In a preferred embodiment, the financial device controller 231 includes a code layer for moving between a platform independent programming language, such as Java, and the device specific interface commands. For example, the financial device controller 231 may imbed KAL commands within Java components for accessing KAL compliant financial devices and associated drivers. The financial device controller 231 may be compliant with the Java extension for Financial Systems (J/XFS). In a preferred embodiment, the financial device controller 231 may include protocols for activating and exchanging data with a card reader, a hardware encryptor, a cash dispenser, a depository, a supervisor mode switch, and other secure devices.

The protocol handler 232 handles communications between the terminal or server system hosting the core application 230 and the switch system 250, or another secure network requiring specific protocols. In one embodiment (not shown), the protocol handler 232 may provide communications with one or more other remote systems, such as supervisor application 260 or transaction application 270. The protocol handler 232 oversees the definition and availability of communication channels for accessing remote resources from the core application 230. The protocol handler 232 may oversee message management, queuing, and routing. In a preferred embodiment, the protocol handler 232 includes two communication channels for each financial services terminal. A first communication channel is for exchange of messages solicited by the financial services terminal, such as those for completing a user transaction through the switch system 250. The second communication channel is for exchange of messages not solicited by the financial services terminal, such as those originating with switch system 250 or another remote system. The protocol handler 232 may include protocols for verifying that a received message is well formatted and that the fields in the message are consistent with the communication and transaction requirements for a given message type. The protocol handler may use data available within the core application 230, such as the data contained in the dictionary module 242 or the session module 241 to build a properly formatted message. The format of the message may be chosen based upon the destination system and purpose of the message. The protocol handler 232 may include routing information for distributing data and events based upon a received message to a plurality of other modules within the core application 230. In a preferred embodiment, the protocol handler 232 updates one or more fields in the dictionary module 242 and forwards the event to the object server for forwarding to the appropriate controller. In a preferred embodiment, the protocol handler 232 may provide an interface for handling multiple communication protocols. For example, protocol handler 232 may include a Document Object Model (DOM) API that treats incoming messages as XML documents and provides handling for both HTML documents provides by a Web server and communications in other formats through another communication manager.

The terminal configuration 233 provides data on the configuration of the financial services terminal for the purposes of determining what transactions should be available through the financial services terminal. In a preferred embodiment, the terminal configuration 233 includes an XML document with fields corresponding to the types of financial devices, input devices, output devices, and other resources available to the financial services terminal. In one embodiment, terminal configuration 233 provides a static view of the hardware and software within the financial services terminal. The terminal configuration 233 may include a view of remote resources available to the financial services terminal as well. In a preferred embodiment, the terminal configuration 233 provides a dynamic view of the resources available to the financial services terminal. For example, the terminal configuration 233 may be updated to represent changes in the availability of large amounts or particular denominations of currency in the cash dispenser. The terminal configuration 233 may be updated when the depository is full, when one or more cards have been captured, or when a device is malfunctioning or otherwise unavailable. The terminal configuration 233 may include a profile of one the core application modules installed within the core application 230, such as the types of transactions 243 and supervisor transactions 245 available. In a preferred embodiment, components accessed by the interface application 220 may include requirements for devices or other resource needed to execute a the functions of the component. The requirements of the component may be compared to the resources available to the financial services terminal prior to offering the component functions to the user. For example, a component corresponding to a deposit transaction would verify the presence and availability of the depository through an inquiry to the terminal configuration 233. If the financial services terminal in question lacked a depository or had a depository that was temporarily unavailable (e.g., full or out-of-order), the core application 230 would notify the component. As a result, the component might not display the deposit transaction or display it in an inactive form, with or without explanation. In one embodiment, the terminal configuration 233 may include logic for quantifying or qualifying the status of a particular resource. For example, the terminal configuration may track the amounts of each currency available through the cash dispenser. Components may include threshold values for comparison to the quantified status to determine whether to offer the component's functions to the terminal user. For example, if the cash dispenser is low on large bills, components corresponding to fast cash transactions for large dollar amounts might be disabled or a maximum limit set on customer withdrawals. In a preferred embodiment, detailed information, in either a static or dynamic version of the terminal configuration 233, may be provided for each cassette in the cash dispenser and the currency or coupon contained in each cash dispenser.

The terminal schedule 234 provides time and event-based logic for determining whether a particular function (and corresponding components) should be made available at a particular financial services terminal. The terminal schedule 234 provides a way to customize the availability of certain types of transactions and services at a particular location. This feature may be particularly advantageous for terminals offering one or more transactions with a potential to be more time intensive, such as information, account management, or e-commerce services. In one embodiment, the terminal schedule 234 may include an XML document providing a time-based schedule of particular functions or types of functions to be offered at the financial services terminal. In one embodiment, the terminal schedule 234 may include time slices defined within the transactions 243 or corresponding components to determine whether the customer transactions should be available at runtime. Components may include a service type or time category for evaluating whether a particular component should be made available to the user. The component may query the core application 230 to determine whether the component function should be offered a terminal user at runtime. The core application 230 may evaluate the component based upon the terminal schedule 234. For example, the terminal schedule 234 for a particular terminal in a particular location may specify that only core services, such as deposits, withdrawals, transfers, and balance inquiries, should be available during the hours of 7 a.m. to 10 a.m., 11:30 to 2 p.m., and 5 p.m. to 7 p.m. A first level of added services, such as bill payment and account management, may be available from 10 a.m. to 11:30 a.m., 2 p.m. to 5 p.m., and 7 p.m. to 7 a.m. A second level of added services, such as e-commerce and opening new accounts, may only be available from 7 p.m. to 7 a.m. If the component request to the core application 230 corresponds to an e-commerce function, the core application will compare the component type to the terminal schedule 234 and return a response telling the component whether or not the function should be made available at the time of the transaction. The terminal schedule 234 may vary according to day of the week, time of the month, or other times. The terminal schedule 234 may also include logic for evaluating other factors to determine when components should be offered. For example, the terminal schedule 234 may take into consideration usage patterns, actual transaction times, time between transactions, or other factors in dynamically reconfiguring the available services. In one embodiment, the financial services terminal may include one or more sensors for evaluating the presence or absence of a customer backlog or other factors for influencing the available services.

The startup module 235 provides instructions and protocols for initially establishing operation of the core application 230 upon its startup. The startup module 235 is the first object loaded by the core application 230. The startup module 235 may perform a number of default functions during startup. For example, the startup module 235 may initialize any financial devices in the financial services terminals, load in memory variables from non-volatile memory (e.g, to provide default data for Session module 241 and Dictionary module 242), check to see if a resource status meets one or more triggering events (e.g., a card has been captured by the card reader), check for recovery or session state information, initialize connection timer and cyclic timer, and verify communication links with one or more remote resources. In a preferred embodiment, the startup module 235 calls the idle loop module 238 upon completion.

The object server 236 provides the interface between the interface application 220 and the core application 230. The object server 236 is responsible for directing queries, data, and transactions received from the interface application 220 to the appropriate module or modules within the core application 230. The object server 236 provides a channel for receiving and responding to data exchange between the interface application 220 and the core application 230. In a preferred embodiment, the object server 236 is a proxy server for directing remote method invocations from components in interface documents 210 to the corresponding modules in the core application 230. The object server 236 may work in conjunction with one or more controllers, such as the default controller 239, the supervisor controller 240, or one or more transaction specific controllers (not shown). The object server 236 may receive method calls from the components and initiate processing in one or more modules. The object server 236 may return the results of the processing as an event to the calling component.

The flow control module 237 oversees coordination of transaction sequences among the various modules in the core application 230. The flow control module 237 ensures that execution of a transaction is not attempted until all requisite data has been gathered from the financial services terminal and other sources. The flow control module 237 may also ensure that, in a series of transactions by the same user in the same session, information requests are not repeated. The flow control module 237 may oversee the maintenance of data in the session module 241 and dictionary module 242 to ensure that the most current data is updated by, available to, and used by each of the other modules in the core application 230. For example, the flow control module may verify that a card has been inserted and read, a PIN has been entered and verified, an amount has been selected, a withdrawal request has been sent to the switch system 250, and response has been received, prior to allowing the financial device controller to dispense the funds. If an additional transaction is initiated, the flow control module 237 will prevent the user from being prompted again for the card or PIN for the same account. In one embodiment, a plurality of flow control modules may be provided corresponding to the flow of specific transactions in transactions 243. However, it may be preferable to have only one flow control module 237 instantiated at any given time.

The idle loop 238 provides processing logic for operation of the financial services terminal outside of a transaction session with a user. The idle loop 238 runs when the financial services terminal runs its attract sequence between customers. The idle loop is responsible for maintaining the connection with one or more systems and applications, such as the host machine (whether the financial services terminal or remote server), the switch system 250, the supervisor application 260, or the transaction application 270. The idle loop 238 may receive an initiating event from startup module 235 or a controller, such as default controller 239 or supervisor controller 240, at the end of the transaction session it controls. Operation of the idle loop 238 may be suspended upon activation of a triggering event and instantiating a controller for the transaction session. The idle loop 238 may be a listener of all events through the protocol handler 232 while the idle loop 238 is alive. In a preferred embodiment, the idle loop 238 may raise two types of events to the object server 236 and the default controller 239. The idle loop 238 may identify an unsolicited event received by the protocol handler 232 and it may identify responses to cyclic monitoring events initiated by the idle loop 238. In one embodiment, the idle loop 238 sends a specific message to and awaits a specific response from one or more systems or applications to verify their present status and continued availability.

The default controller 239 provides processing logic for a customer transaction session from initiation of the session until control can be passed to one of the transactions 243. The default controller 239 receives notice of a triggering event from the object server 236. For example, the default controller 239 may receive notification that a card has been inserted in the card reader of a financial services terminal. The default controller 239 may be responsible for monitoring the resulting customer session until a particular user transaction is selected and control can be passed to one of transactions 243. For example, once the user has selected a withdrawal transaction, control is passed from the default controller 239 to the corresponding transaction from among transactions 243 in core application 230. The default controller 239 becomes the destination module for events directed to the object server 236. The default controller 239 populates the session module 241 with default information and information gathered during the trigger event. Depending on the customer interface flow design of the interface documents, the default controller 239 may maintain control through a number of interface documents and may be responsible for monitoring additional exchanged between the financial services terminal and the user. For example, the interface documents may prompt for additional information, such as PIN, prior to the selection of a particular transaction. The default controller 239 may be responsible for gathering more data for the session module 241 or dictionary module 242. In one embodiment, the default controller 239 may remain instantiated during processing under one of the transactions 243. The default controller 239 may provide an interface between the transactions 243 and the object server 236, the session module 241, and the dictionary module 242. In one embodiment, the default controller 239 may include logic for handling some errors that may occur in processing a transaction.

The supervisor controller 240 provides processing logic for a supervisor transaction session from the time the supervisor transaction session is initiated until control is passed to a selected one of supervisor transactions 245. The supervisor controller 240 may be very similar to the default controller 239, except that it handles supervisor sessions rather than customer sessions. Initiation of the supervisor controller 240 may be based upon an initiating event for a supervisor mode, such as the input of a supervisor card in the card reader, entry of a supervisor code, actuation of a supervisor switch, or other ways of selecting a supervisor transaction. In one embodiment, initiation of a supervisor mode for at least some supervisor transactions may be initiated remotely by a remote supervisor application, such as the supervisor application 260. In one embodiment, the supervisor controller 240 may remain instantiated during processing under one of the supervisor transactions 245. The supervisor controller 240 may provide an interface between the supervisor transactions 245 and the object server 236, the session module 241, and the dictionary module 242.

The session module 241 contains the context of a current transaction session. The session module 241 may provide a number of variables specific to the customer and the transaction or transactions being handled. In a preferred embodiment, the session module 241 is persistent. The startup module 235 will look for the last session object in order to initiate a recovery of an interrupted transaction if necessary. The session module 241 may be created when a customer or supervisor transaction is initiated and persists until the particular customer or supervisor session is complete, which may include multiple transactions. In one embodiment, the session module 241 may be a front end portion for the dictionary module 242. The session module 241 may provide a runtime data management function so that other modules can access data for the current transaction only. In one embodiment, the session module 241 may not be accessible to the transactions 243 themselves except through a controller, such as the default controller 239 or the supervisor controller 240. In this way, transactions 243 may be unaware of the variables, such as the actual amount of a withdrawal transaction, and only oversee the logical flow of the transaction session.

The dictionary module 242 contains the global data used by many of the other modules in the core application 230. The dictionary module 242 may include a variety of data including constants, terminal information, customer information, transaction logs, messages received and sent, session information, supervisor information, and other information. The dictionary module 242 may provide a single repository for data used in the transactions 243. The dictionary module 242 may also include data for use by other modules, such as protocols settings for the financial device controller 231 or the protocol handler 232, the configuration and schedule settings for the terminal configuration 233 and the terminal schedule 234, default settings for startup module 235, etc. In a preferred embodiment, the dictionary module 242 provides a centralized location for managing a variety of information utilized by the other modules. The dictionary module 242 may include a data repository and an associated data management application.

The plurality of transactions 243 are modules for providing processing and/or monitoring of a plurality of customer transactions that can be executed through the financial services terminal. Each of the transactions 243 may correspond to a particular customer transaction or a portion thereof. For example, their may be transactions 243 corresponding to a withdrawal transaction, a transfer transaction, a balance inquiry transaction, a deposit transaction, a information search transaction, a purchase transaction, or other customer transactions. The transactions 243 may include: modules that provide the processing logic for locally executing a customer transaction, modules that provide a portion of the processing necessary to submit a transaction request to a remote system (e.g., the switch system 250), and modules that monitor a transaction request executed by the interface application 220 to a remote transaction system (e.g., the transaction application 270). The transactions 243 may be associated with and called by one or more components in the interface documents 210, such as the components 212, 213, and 214. The component may, through the object server 236, call a corresponding transaction using an RMI compliant method call. The component may then await a response from the called transaction. In one embodiment, the processing logic for coordinating fulfillment of the customer transaction resides in the transactions 243, as opposed to within the components themselves. The components merely call the corresponding transactions 243. Once called, the transaction may verify that data for fulfilling the transaction is present in the dictionary module 242 and the session module 241. If the data is not present, such as when a PIN is still required from the user or the transaction relies on data exchange with the switch system 250, the transaction may await completion of the data before returning a result. If the data is not present, the transaction may return a result for prompting the component to raise an event to a director and initiate further data gathering from the customer. If the data is not present, the transaction may initiate action by other modules in order to generate the data, such as by calling the protocol handler to initiate an exchange with the switch system 250. In the case of a locally processed transaction, the transaction may contain the logic for operating upon data in the dictionary module 242 or session module 241 for completing the transaction. In the case of a customer transaction being processed by a system in communication with the interface application, the transactions 243 may merely verify that information regarding the transaction is recorded in the dictionary module 242, session module 241, or an appropriate log, such as the transaction log 244. Alternatively, the transactions 243 may retrieve data from one or more financial devices or other resources available to the core application 230 and return that data as a result to the component, so that the component can use the data in executing the transaction through another system. For example, the customer transaction may require card data from the card reader be submitted to transaction application 270. Any of transactions 243 may include a combination of local processing, overseeing processing through core application resources, and providing data to or monitoring of processing through resources available to the interface application 220. In one embodiment, evaluation of terminal configuration requirements for a given customer transaction and corresponding component(s) will be executed by a corresponding one of transactions 243. The transaction may include the requirements and compare them to the terminal configuration 233. The transaction may also evaluate the terminal schedule 234 for the customer transaction.

The transaction log 244 provides a record of each actual customer transaction session provided through the financial services terminal. The transaction log 244 provides a resources for reviewing the technical history of transactions for maintenance of the financial services terminals. The transaction log 244 may also provide a resource for abstracting data helpful in revising, designing, and implementing existing and additional services through the financial services terminals. The transaction log 244 may receive and record trace data from any or all of the other modules within the core application 230. In a preferred embodiment, the transaction log 244 is a module that receives the contents of the session module 241 at the end of each customer transaction session. The data from the session module 241 may be dumped into a file, database, or other data repository associated with the transaction log 244. In one embodiment, the transaction log 244 may include one or more data management functions. For example, the transaction log 244 may receive commands from one of supervisor transactions 245, the supervisor application 260, or another source to pass some or all of the data in the transaction log 244 to another module or resource. This may allow the transaction log 244 to be printed through a receipt printer or viewed in an interface document at the financial services terminal during a supervisor transaction. This may allow the transaction log 244 to be downloaded and viewed, saved, or printed by the supervisor application 260 from a remote location.

The plurality of supervisor transaction 245 are modules for providing processing and oversight for one or more supervisory functions executed locally at the financial services terminal or remotely using the supervisor application 260. The supervisor transactions 245 may be substantially similar in function to the transactions 243 described above. The supervisor transactions 245 may be linked to one or more supervisor components, such as supervisor component 218, in the interface documents 210. The supervisor transactions 245 may provide local processing, coordinate access of other core system resources, or oversee interactions with one or more remote application. At least some of the supervisor transactions 245 may be initiated by remote calls from the supervisor application 260. For example, the supervisor application may use RMI compliant calls to access the core application 230 through the object server 236.

The object library 280 is a management resource including a number of object modules that may be used in the generation of the interface documents 210. The object library 280 provides a resource for centralizing objects for inclusion in the interface documents 210. The same objects may be included in the interface documents 210 of multiple financial services terminals. In one embodiment, the object library 280 includes a plurality of components that may be embedded in the interface documents 210. In one embodiment, the objects within the object library 280 are embedded by a reference to their identification or location within the object library 280 and are dynamically accessed at runtime. The object library 280 may also include content objects, directors, templates, and other objects. In one embodiment, the object library 280 may include tools for managing, editing, and generating new objects.

The example component 281 shows several features of a component, such as components 212, 213, and 214 or supervisor component 218. The component 281 includes a display module 282, an input event module 283, a requirements module 284, and an action module 285. In one embodiment, each of the modules may comprise one or more fields in a form for creating a custom applet.

The display module 282 may provide a text, graphic, sound, or other display object associated with the component 281. The display module 282 is integrated into the interface document and displayed to the customer through the financial services terminal. For example, the display module 282 may include a text entry to provide a label for a menu entry or button. The display module 282 may include a graphic file depicting a button, label, or menu entry. The display module 282 may include a sound file for providing a voice menu, transaction description, or other instructions for guiding customer decisions.

The input event module 283 may define the input conditions for triggering the component 281. The input event module 283 maps the function of the component 281 to one or more input devices in the financial services terminal. For example, the input event module 283 may associate the component with actuation of a function key, a pre-defined input from a keypad, insertion of a card into the card reader, or another triggering event. In one embodiment, the component 281 may include multiple triggering events or triggering events including multiple trigger conditions.

The requirements module 284 may define a set of requirements that must be present in the financial services terminal in order to provide the function of component 281. The requirements module 284 may be evaluated prior to display of the component 281 at the financial services terminal. If the requirements are not met, the component 281 may not be displayed or may be displayed in such a way as to indicate that it is non-functioning. Alternatively, the requirements may be evaluated when the triggering event for the component is met and failure to meet the requirements will redirect the flow of the transaction to a message that the function is not available. The requirements module 284 may include specifications regarding the input, output, or financial devices required in order to execute the component's function. The requirements module 284 may include a function priority, classification, or other specific conditions that may be used to evaluate whether the component's function should be offered under the present circumstances of the financial services terminal and customer. For example, the requirements module 284 may include information related to scheduling that determine whether the component 281 should be offered at the time. The requirements module 284 may include information related to whether a particular customer, such as a host bank customer versus non-host bank customer, should be offered the functions of the component 281. The requirements of the requirements module 284 may be evaluated against the terminal configuration 243, the terminal schedule 244, or other modules within the core application 230 or another resource, such as the supervisor application 260 or the transaction system 270.

The actions module 285 defines the actions to be executed by the component 281 when one or more triggering events and requirements are met. The action module 285 may include actions such as performing a calculation, retrieving data from an input device, sending data or a method call to the core application 230, sending data or a transaction request to the supervisor application 260 or the transaction application 270, raising an event to a director, or another action. The action module 285 may include multiple actions for the component 281. For example, once a triggering event specified in input event module 283, the component 281 may perform several actions. The component 281 may identify data input through the keypad of the financial services terminal and pass that data in a method call, identifying itself and the its destination transaction, to the object server 236 of the core application 230. The component 281 may await a response from the core application 230 representing that the data passed has been added to the appropriate portions of the session module 241 and dictionary module 242 and that the appropriate one of transactions 243 has been initiated. It may also trigger a counter for the supervisor application 270 intended to gather metrics regarding the selection of the function that the component 281 corresponds to. It may also raise an event to one of the directors for the interface document the component 281 is embedded in to begin loading of the next interface document. In one embodiment, the actions included in the component 281 may be predefined. For example, a plurality of components including different actions or combinations of actions may be categorized and selected by function.

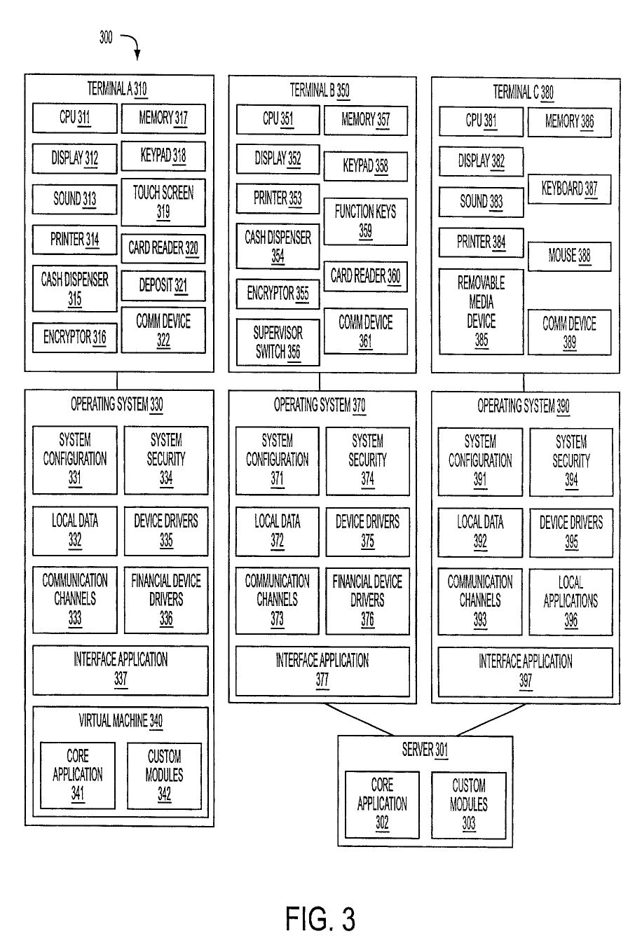

FIG. 3 shows a system 300, a number of financial services terminals 310, 350, and 380, and a number of software configurations 330, 370, and 390 associated with the financial service terminals 310, 350, and 380 respectively. The server system 300 also includes a server 310 providing a portion of the software configuration for the financial services terminals 350 and 380. The system 300 shows a variety of example financial services terminal configurations and associated software systems. The system 300 may provide the hardware and software supporting at least a portion of the system 200 shown in and described with regard to FIG. 2 above. The financial services terminals 310, 350, and 380 and the associated software configurations 330, 370, and 390 provide delivery of financial services based upon a plurality of interface documents (not shown in FIG. 3). In one embodiment, the interface documents may be stored locally. In a preferred embodiment, each of the financial services terminals in the system 300 may be connected to one or more remote servers (not shown in FIG. 3). For example, the financial services terminals 310, 350, and 380 may be connected to a remote server providing interface documents, such as an HTML server. The financial services terminals 310, 350, and 380 may also be connected to one or more servers hosting a transaction application or a supervisor application. In one embodiment, the financial services terminal 310 and the server 301 may be connected to a switch system providing access to a financial data network. In alternate embodiments (not shown in FIG. 3), a wide variety of terminal devices and associated software configuration may be used to access an interface document driven financial services system. For example, other terminal devices may include personal communication devices, personal digital assistants, personal computers, internet appliances, interactive televisions, and other network devices.

Each of the financial services terminals 310, 350, and 380 include a number of devices for providing financial services to a customer. For example, the financial services terminal 310 includes a CPU 311, a display device 312, a sound device 313, a printer device 314, a cash dispenser device 315, an encryptor device 316, a memory device 317, a keypad device 318, a touch screen device 319, a card reader device 320, a deposit device 321, and a communication device 322. The financial services terminal 310 might represent an example full-service, touch screen driven ATM such as is commonly found at bank branches.

Each of the financial services terminals 310, 350, and 380 also includes a software configuration based upon an operating system, such as Microsoft Windows NT™. For example, the financial services terminal 310 includes the software configuration 330. The software configuration 330 associated includes a system configuration 331, a local data source 332, a plurality of communication channels 333, system security settings 334, device drivers 335, financial device drivers 336, and an interface application 337. The financial services terminal 310 may also host a virtual machine 340 including a core application 341 and a plurality of custom modules 342. In one embodiment, the core application 341 may include modules for overseeing the financial services functions of the financial services terminals, as described above with regard to the core application 230 shown in FIG. 2. Custom modules 342 may include transactions, supervisor transactions, and other modules that may not be common to all financial services terminals.

As another example of a configuration of devices for a financial services terminal, the financial services terminal 350 includes a CPU 351, a display device 352, a printer device 353, a cash dispenser device 354, an encryptor device 355, a supervisor switch 356, a memory device 357, a keypad device 358, a function keys device 359, a card reader device 360, and a communication device 361. The financial services terminal 350 may represent an example portable high security ATM with limited functions such as might be found in convenience stores or gas stations remote from a bank branch.

As another example of the configuration of software elements for a financial services terminal, software configuration 370 associated with the financial services terminal 350 includes a system configuration 371, a local data source 372, a plurality of communication channels 373, system security settings 374, device drivers 375, financial device drivers 376, and an interface application 377. A core application 302 and a plurality of custom modules 303 may be hosted on server 301, physically separated from the financial services terminal 350. In one embodiment, the server 301 may be connected to financial services terminal 350 as part of a local area network. In an alternate embodiment, the server 301 may be accessed over a wide area network. The server 301 may act as an application server for the core application 302 and the plurality of custom modules 303.

As still another example of a configuration of devices for a financial services terminal, the financial services terminal 380 includes a CPU 381, a display device 382, a sound device 383, a printer device 384, a removable media device 385, a memory device 386, a keyboard device 387, a mouse device 388, and a communication device 389. The financial services terminal 380 may represent an example PC-based financial services kiosk, such as may be provided in a mall or bank lobby

As another example of the configuration of software elements for a financial services terminal, software configuration 390 associated with the financial services terminal 380 includes a system configuration 391, a local data source 392, a plurality of communication channels 393, system security settings 394, device drivers 395, one or more local applications 396, and an interface application 397. The local applications 396 may include other software applications using more typical PC security standards. Such applications may utilizing the increased input/output features, such as a full keyboard, a mouse, and a removable media device, for providing additional functions through the terminal. As with software configuration 370 described above, the core application 302 and the plurality of custom modules 303 may be hosted on server 301, physically separated from the financial services terminal 380.

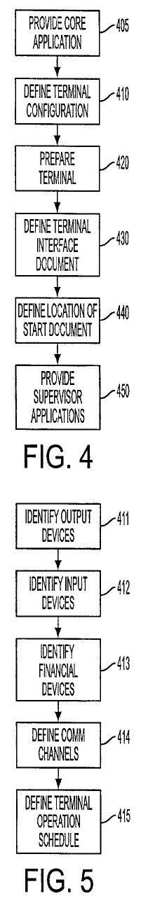

FIG. 4 shows an example method of preparing a plurality of financial services terminals. In step 405, a core application for overseeing operation of the financial services terminal is provided. In step 410, a terminal configuration is defined for one of the financial services terminals. In step 420, the financial services terminal corresponding to the defined terminal configuration is configured. In step 430, at least one terminal interface document is defined for use in the configured financial services terminal. In step 440, a location for a start document is defined for the configured financial services terminal. In step 450, one or more supervisor applications are provided in a server system with access to the configured financial services terminal. One or more steps may be repeated for each of the plurality of financial services terminals.

In step 405, the core application may be provided by installing the core application locally on the financial services terminal. Installing the core application may include first installing virtual machine alongside the existing operating system of the financial services terminal. Alternatively, the core application may be provided on a system remote from the financial services terminal. The core application may already be installed on the remote system, such as where the core application is already servicing other financial services terminals. The core application may be provided by configuring the core application for receiving method requests and identifying the location of the core application, specifically an object server associated with the core application. In one embodiment, the interface documents and components therein may already be configured for the location of the object server, whether local or remote

In step 410, the configuration of the financial services terminal may be defined by accessing a terminal configuration module in the core application. In one embodiment, defining the configuration may include providing a document including the terminal configuration data. The document may follow standard formatting or a template for describing the default configuration of the financial services terminal. The location of the document may be identified to the terminal configuration module in the core application by providing the location to the terminal configuration module or placing the document in a standard location known to the terminal configuration module. In one embodiment, the configuration of the financial services module provided to the core application may be the default configuration of the financial services terminal. The configuration may identify the location, type, and access protocols for various financial devices. The configuration may be used by the core application to dynamically modify the default configuration according to the present status of any given device (e.g., depository full, cash dispenser empty, card reader out-of-order, etc.). Defining a terminal configuration may be achieved by identifying a known type or model of terminal device functioning as a financial services terminal and associating a standard configuration with the identified terminal device. Further details of defining the terminal configuration are provided below with regard to the method shown in FIG. 5.

In step 420, the financial services terminal is prepared for providing financial services based upon a plurality of interface documents and an associated core application. The financial services terminal may be prepared by configuring one or more settings in the operating system of the financial services terminal, configuring one or more devices within the financial services terminal, providing one or more applications to the financial services terminal, and configuring one or more settings in the provided applications.

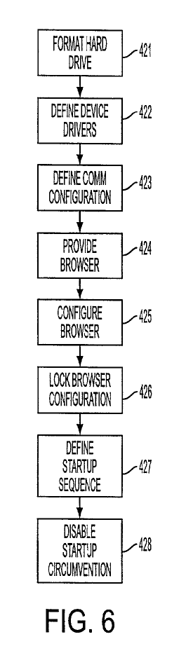

Further details of preparing a financial services terminal are described below with regard to FIG. 6.

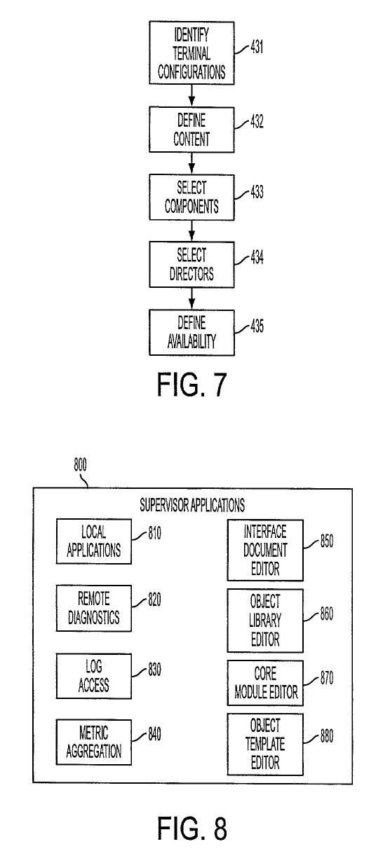

In step 430, a set of interface documents is defined for the financial services terminal. One or more of the interface documents may be created or customized for the particular financial services terminal. One or more of the interface documents may be identified from a preexisting set. The preexisting set may be shared by a plurality of financial services terminals. In a preferred embodiment, the interface documents are located remotely on an interface document server, such as an HTML server. In an alternate embodiment, the interface documents may be provided in a local data source. Further details of preparing one or more interface documents are described below with regard to FIG. 7.

In step 440, a location of a start document may be defined in the financial services terminal. The start document may be provided as the default location accessed by an interface application, such as a home page. The start document provides a starting point for operation of the financial services terminal. The interface application goes to the start document when the interface application is loaded, such as on startup of the financial services terminal. Operation flow between a set of interface documents associated with the financial services terminal may be provided beginning from the identified start document.

In step 450, one or more supervisor application may be provided for the financial services terminal. Provision of a supervisor application may be inherent in the core application and the interface documents provided for the financial services terminal. No additional actions may be necessary to provide the supervisor application. For example, the core application may include one or more supervisor transactions and a supervisor controller. The interface documents associated with the financial services terminal may include one or more supervisor components or may include one or more subsets of interface documents for providing a local supervisor application interface. Providing the supervisor application may include configuring one or more local devices such as a supervisor switch in the financial services terminal or may include identifying a supervisor card and/or PIN within the core application, interface documents, or another portion of the system.

FIG. 5 shows an example method of defining a terminal configuration for a particular financial services terminal. In step 411, one or more output devices are identified for the financial services terminal. In step 412, one or more input devices are identified for the financial services terminal. In step 413, one or more financial devices are identified for the financial services terminal. In step 414, one or more communication devices are identified and communication channels are defined for the financial services device. In step 415, a terminal operation schedule for the financial services terminal is defined.

In step 411, the output devices associated with the financial services terminal are identified. Common output devices may include a CRT and associated video card, other display devices, one or more speakers and associated sound card, other sound devices, a printer, a removable storage media device, other devices for tangible output, lights, and other devices for conveying information or attracting attention. The output devices may be identified by general type, size, location, and capabilities. For example, the display may be a 17″ color monitor, a 6″ monochrome monitor, or a 3″ display for a PDA. The output devices may be identified according to the location, protocol, or method of accessing the output device within the financial services terminal.

In step 412, the input devices associated with the financial services terminal identified. Common input devices may include keypads, keyboards, function keys, touch screens, microphones, biometric devices, cameras, sensors, and other devices for receiving information at the terminal. The input devices may be identified by general type, types of input available, configuration, and location. For example, a keypad may be identified as including keys labeled 0-9, # and *, the locations of the individual keys may be specified, the numeric or binary nature of the input may be identified, and other information that would be useful in customizing the user interface of the financial services terminal may be identified. The input devices may be identified by their location, protocol, or method of receiving data from the input device in the financial services terminal.

In step 413, the financial services devices for the financial services terminal are identified. Example financial services devices may include a sheet dispenser or other cash dispenser, a coin dispenser, a roll dispenser or other coupon/ticket/token dispenser, a depository, an encryptor, a card reader, a supervisor switch, or other secure device related to the operation of the financial services terminal. The financial services devices may be identified according to general type, configuration, and details according to type. For example, a cash dispenser may be identified as a number of cassettes and the contents (such as currency and denomination) within those cassettes. The financial services devices may be identified by their location, protocol, or method of actuation in the financial services terminals. The identification of the financial services terminals may allow modules in the core application to be defined to interface with the financial services devices.

In step 414, the communication channels for the financial services terminal are defined. The communication channels may include a variety of ports, network cards, modems, and similar devices. The communication channels may include the identification of particular sockets for establishing communications with other systems, such as virtual machine or server providing the core application, a data source or server for the interface documents, a server hosting a transaction system, a server hosting a supervisor application, or other systems. The communication channels may be defined to be compatible with a local area network, such as a bank intranet, or a wide area network, such as the internet. The communication channels may be defined in such a way as to provide the location, protocols, and methods of accessing the communication channels.

In step 415, the terminal operation schedule is defined. The terminal operation schedule may include basic information regarding the days and times when the terminal is scheduled to in operation. The terminal operation schedule may include information based upon the traffic flow and time variable intended purposes of the financial services terminal. The terminal operation schedule may define one or more interrelated categories for determining what functions should be available through the financial services terminal at what times. The terminal operation schedule may include logic for dynamically analyzing events related to the operation of the financial services terminal, such as time of transactions, time between transactions, data regarding the presence of waiting customers, and other information.

FIG. 6 shows an example method of configuring a financial services terminal. In step 421, a hard drive or other data storage device is formatted for secure data access. In step 422, one or more device drivers are defined for one or more input devices, output devices, financial devices, or communication devices. In step 423, one or more communication channel configurations are defined for use of one or more communication devices. In step 424, a browser or other interface application is provided to the financial services terminal. In step 425, the browser or other interface application is configured according to various security requirements. In step 426, the configuration for the browser or other interface application is locked to prevent modification or circumvention of the security measures. In step 427, a startup sequence for enabling specific and limited resources to operate on the financial services terminal is defined. In step 428, system and application inputs for locally circumventing the startup sequence are disabled.

In step 421, one or more hard drives or other persistent memory devices are formatted according to a security standard designed to limit access to the hard drive. In a preferred embodiment, the operating system of the financial services device includes a security standard for memory devices that allows only an individual with administrator status authority to access or alter the settings of the memory device. The memory device may be integrated into the security protocols of the operating system and access privileges and restrictions may be defined within the operating system. For example, Microsoft Windows NT™ includes NTFS format for hard drives. Formatting a hard drive may include partitioning the hard drive for access by the base operating system of the financial services terminal and a virtual machine hosted by the financial services terminal.

In step 422, device drivers for the input devices, output devices, and financial devices are defined. Defining the device drivers may include providing and configuring one or more device drivers related to each device. In one embodiment, one or more device drivers are provided in conjunction with the operating system of the financial services terminal. The device drivers may be defined for access from applications running within the operating system. In one embodiment, one or more device drivers may be defined for access through a virtual machine installed over the operating system. In this way, some devices, such as financial devices, may be defined for access only by applications running in the virtual machine. Such devices may be inaccessible to applications running within the operating system environment. For example, a card reader may be defined through a virtual machine supporting the core application, while a monitor may be defined through the operating system supporting the interface application. One or more devices may be defined to be accessible from a remote application through a communication channel. For example, a core application on a remote server may provided with control over one or more financial devices.

In step 423, a plurality of communication configurations are defined. The financial services terminal may include a plurality of communication devices and input/output ports. The communication devices and ports may be defined to provide one or more communication channels. In a preferred embodiment, some communication channels may be defined for access through the operating system of the financial services terminal. Some of the channels may be defined for access from a virtual machine. In one embodiment, one or more communication channels may be configured specifically for communication with a particular remote system, such as a data network, HTML server, core application server, or other remote system.

In step 424, a browser may be provided for the financial services terminal to act as an interface application. Any browser capable of displaying the interface documents and accessing the applets associated therewith may be provided. For example, the browser may include a general purpose browser, such as Internet Explorer™ or Netscape Navigator™, a browser for Palm OS, an interactive television browser, or another more specialized browser application for the financial services terminal.

In step 425, the browser provided in step 424 may be configured to limit the uses of the browser according to the purpose of the financial services terminal. Configuration settings may include providing filters or settings to limit the types of remote resources, local devices, applets and plug-ins, interface documents, and other resources the browser application may access.

In step 426, the browser configuration set in step 425 may be locked to limit future modification of the browser configuration by unauthorized persons, such as customer users. In one embodiment, the tools for accessing or altering the browser configuration may be disabled. The tools may be hidden such that specific knowledge of their location is required to access them. The tools may be locked such that an administrator password is required or other verification of identity is required to access the tools.

In step 427, the startup sequence of the financial services terminal may be defined. For example, when the financial services terminal is powered up or reset, the startup sequence may be defined to provide routine security, system maintenance, and virus protection. The startup sequence may then load one or more applications, such as the browser. The browser may access and load a defined start document from among the interface documents available to the financial services terminal. In one embodiment, the startup sequence may also include start of the virtual machine and initiation of the core application. The core application may initiate a startup module. The startup sequence may include diagnostics for verifying one or more remote resources for the financial services terminal.

In step 428, circumvention of the startup sequence is disabled or otherwise secured. Standard circumvention methods may include providing an alternate boot device or allowing input device commands to interrupt the startup sequence. Both of these standard methods may be disabled. A secure alternative method of interrupting the startup sequence may be provided, such as a method involving use of a supervisor switch of card. Disabling circumvention may include configuring the operating system and providing one or more custom start scripts.

FIG. 7 shows an example method of defining a terminal interface document. In step 431, a terminal configuration is determined for one or more financial services terminal that the interface document is intended to run on. Identification of one or more terminal configurations may be helpful in determining the content, components, and directors appropriate to the available input devices, output devices, and financial devices.

In step 432, content is defined for the terminal interface document. In step 433, one or more components are selected and added to the terminal interface document. In step 434, one or more directors are selected and added to the terminal interface document. In step 435, availability is defined for the terminal interface document or components thereof.

FIG. 8 shows a supervisor applications module 800 for use in association with a system connected to a plurality of financial service terminals. The supervisor applications module 800 may include a number of tools for monitoring, maintaining, and updating a plurality of financial services terminals and associated interface documents, object libraries, core applications, and other portions of a financial services system. The supervisor applications module 800 may include a variety of modules for providing supervisory functions for one or more financial services terminals. In one embodiment, the functions of the supervisor applications module 800 are provided through a remote supervisor application in communication with the other components of a financial services system. The functions of the supervisor applications module 800 may be supported by a core applications, such as a core application including supervisor transactions and a supervisor controller. The functions of the supervisor applications module 800 may be supported by interface documents, such as interface documents with supervisor components or a set of supervisor interface documents. The supervisor applications module 800 includes a local application module 810, a remote diagnostics module 820, a log access module 830, a metric aggregation module 840, an interface document editor module 850, an object library editor module 860, a core module editor module 870, and an object template editor module 880.

The local application module 810 provides a variety of maintenance and administrative functions to be performed at a financial services terminal. For example, the local application module 810 may provide an interface and functions for use by a technician onsite at the financial services terminal. The local application module 810 may include functions such as accessing the contents of a depository, refilling or changing the cassettes of a cash or other type of dispenser, recovering cards captured by a card reader, or accessing other software or hardware for diagnostics, maintenance, repair, or replacement. In one embodiment, the local application module 810 may allow a technician to access one or more local devices for downloading data from the financial services terminal or uploading data to a remote data repository, such as a data repository associated with a remote supervisor application. In one embodiment, the local application module 810 operates through a set of interface documents that provide the interface and functions for the local supervisory functions. The local application module 810 may be accessed by actuating a supervisor switch, providing a PIN, using a supervisor card, or some combination thereof. In one embodiment, the activation of the local application module 810 may be reported to a remote supervisor application. In one embodiment, the activation of the local application module 810 may require verification from a remote supervisor application.

The remote diagnostics module 820 may allow a remote technician run one or more diagnostics for gathering current information on the status of one or more portions of the financial services terminal. The remote diagnostics module 820 may allow a remote supervisor application to initiate one or more applications that gathers data from financial services terminal resources and returns data to the financial services terminal. For example, the remote supervisor application may be able to communicate a method call to an object server in a core application associated with the financial services terminal. The object server may recognize the method call and initiate a supervisor mode by passing control to a supervisor controller and initiating one or more supervisor transactions. The supervisor transactions may include diagnostic logic for verifying the operation of various modules and devices. For example, a supervisor transaction may initiate a test message through a protocol handler to a switch system and be returned a data regarding the success or failure of the attempt.

The log access module 830 may allow a technician, either locally or remotely, to access a data source associated with a particular financial services terminal. The log access module 830 may be accessed locally in a way similar to the local application module 810. The log access module 830 may be accessed remotely in a way similar to the remote diagnostics module. The log access module 830 may be facilitated by one or more data sources accumulating data regarding the operations of the financial services terminal. For example, the core application may include a transaction log that accumulates information regarding each transaction executed through the financial services terminal. The core application may accumulate data regarding the state of one or more devices in the financial services terminal, such as the contents of a depository, cash dispenser, card reader (with card capture functions), or other devices. In one embodiment, the log access module 830 may access a history log of the interface application associated with the financial services terminal.

The metric aggregation module 840 may provide aggregated data regarding transactions and customers. In one embodiment, the metric aggregation module 840 may include supervisor components embedded in the interface documents of the financial services terminals that monitor information regarding the execution of transactions. The supervisor components may report the information to a data repository associated with the metric aggregation module. The metric aggregation module 840 may aggregate data from multiple financial services terminal and allow a technician to use a variety of data mining tools for abstracting information from the aggregated data.

The interface document editor 850, the object library editor 860, the core module editor 870, and the object template editor each provide editing and management tools for the objects associated with the particular editor. For example, interface document editor 850 may be an HTML editor for editing and managing interface documents associated with one or more financial services terminals. In one embodiment, the interface document editor 850 may include a wizard for assembling a plurality of interface documents to match a desired transaction flow at the financial services terminal. The wizard may rely on predefined templates, content objects, components, and directors to assemble a set of interface documents. The object library editor 860 may be an applet editor and content management tool for customizing content objects, components, and directors. The core module editor 870 may be an application editor for customizing application modules, such as method objects. The core module editor 870 may allow a user to edit and create transactions or other modules for a core application associated with one or more financial services terminals. The object template editor 880 may be an editor for creating object templates to be used by the object library editor 860. The object templates may ensure compatibility with the object server and transaction modules of the core application. Each of the editors may include management tools and protocols for accessing, editing, and delivering new objects to the locations where they are accessed by the financial services terminals.

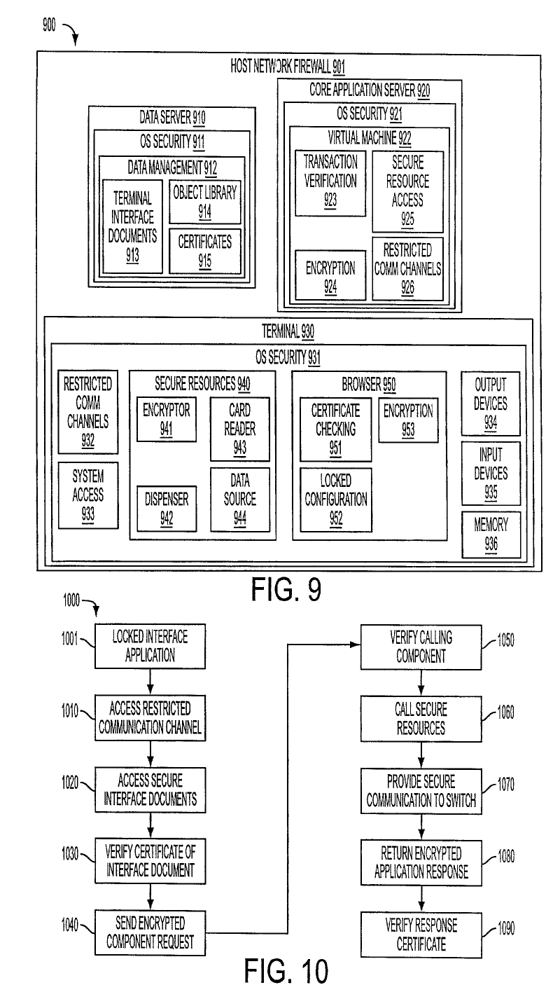

FIG. 9 shows example security features for a financial services system 900 including a server system and associated financial services terminals. The financial services system 900 may include systems or portions of systems and methods, such as those described above for FIGS. 1-8. The server system and financial service terminals may be enclosed within a host network firewall 901. The server system may include a data server 910 and a core application server 920. The financial server terminals may include a plurality of terminals, such as terminal 930. FIG. 9 shows the core application server 920 as opposed to a core application resident in the financial services terminals themselves. However, similar security features may be implemented in a system with core applications resident within the financial services terminals.

The data server 910 includes several security layers. The data server 910 includes an operating system (OS) security layer 911 and a data management security layer 912. The OS security layer 911 may include a variety of security features included in the operating system. For example, the OS security layer 911 may include procedures for defining access privileges based upon identity and denying access to resources of the data server 910 in excess of defined privileges. The data management security layer 912 may include security features associated with a selected data management application. For example, the data management application may include access privileges and access logs for monitoring access, use, and modification of data in data server 912. There may be security associated with the server hardware for the data server 910 as well. The data server 910 includes several data sources related to financial service terminal security.

The data server 910 includes secure terminal interface documents 913, a secure object library 914, and a secure certificates library 915. The security layers of the data server 910 protect and monitor access, use, and modification of the contents of the data server 910. The data contained in data server 910 may be used by other portions of the financial services system 900 to fulfill additional runtime security features, such as certificate checking and restricted locations for accessing interface documents, applets, and other files.

The core application server 920 includes several security layers. The core application may host a number of core application modules that support the operation of one or more financial services terminals, such as the terminal 930. The core application server 920 includes an operating system (OS) security layer 921 and a virtual machine security layer 922. The OS security layer 921 and the virtual machine security layer 922 for the core application server may be comparable to the OS security layer 911 of the data server 910. There may be security associated with the server hardware as well. Core Application Server 920 includes several security features related to financial service terminal security. These security features may be embodied in one or more functional modules or may be a distributed aspect of a plurality of functional modules. The core application server 920 includes an transaction verification module 923, an encryption module 924, a secure resource access module 925, and a restricted communication channels module 926.

The transaction verification module 923 allows the core application to verify the method calls and other communications to which it will respond. The transaction verification module 923 may include certificates, identifiers, or other security elements associated with the protocols for accessing the functional modules. For example, a protocol handler in the core application may include logic for authenticating the source and format of communications from another system, such as a switch system. An object server in the core application may include logic for verifying the source of a method call or other communication received. In a preferred embodiment, the core application includes data, transactional abilities, and access to financial devices. The transaction verification module 923 ensures that only authorized sources may make user of the core applications functions.

The encryption module 924 may provide data encryption for communications between the core application server 920 and other resources inside or outside of the financial services system. The encryption module 924 may include an encryption standard associated with a protocol handler or other communication module. For example, the encryption module 924 may encrypt all communications to the terminal 930 and decrypt all communications from the terminal 930 according to RSA encryption standards. The encryption module 924 may provide encryption for all communications directed to a wide area network. In one embodiment, the encryption module utilize a secure hardware encryptor to provide encryption of all or part of communications to other resources.

The secure resource access module 925 may provide access to one or more secure devices associated with a financial services terminal, such as the terminal 930. The resources may be remote to the core application server 920. In a preferred embodiment, the resources are located in the financial services terminal but cannot be accessed directly by applications within the financial services terminal. The secure resource access module 925 may include a financial devices controller in the core application that may only be accessed through the other security layers provided by the core application, such as the transaction verification module 923, encryption module 924, and the restricted communication channels module 926. For example, an attempt to access one of the secure resources may require access to a restricted communication channel and a method call including appropriate verification information. The secure resource access module 925 may be able to access a communication channel with the secure device and format an appropriate instruction set for operating the device.

The restricted communication channels module 925 may provide one or more restricted communication channels for communicating with one or more other resources. Some restricted communication channels may be configured such that they may communicate only with a particular destination resource. Some restricted communication channels may be configured such that they only accept messages from a particular destination. In a package based network, this may include verifying one or more fields corresponding to the originating system. In one embodiment, the restricted communication channels module 925 may include filters configured to identify communications from acceptable sources. In one embodiment, one or more communication channels may be configured only for two-way communications with a specific source, such as the terminal 930.

The terminal 930 includes several security layers. The terminal 930 includes an operating system (OS) security layer 931 and security layers associated with one or more component modules. The OS security layer 931 in the terminal 930 may be substantially similar to the OS security layers 911 and 921 described above with regard to the data server 910 and the core application server 920. The terminal 930 includes a restricted communication channels module 932, a system access module 933, a secure resources module 940, and a browser module 950. The restricted communication channels module 932 may be substantially similar to the restricted communication channels module 926 described above with regard to the core application server 920. System access module 933 may be a module for providing limited access to system and startup settings for the terminal 930. The terminal 930 also includes one or more output devices 934, one or more input devices 935, and one or more memory devices 936. Additional security features may be associated with any devices, protocols, or associated drivers in Terminal 930.

The secure resources module 940 may include secure drivers and limited access to one or more secure resources. The example secure resources shown are an encryptor module 941, a dispenser module 942, a card reader module 943, and a data source module 944. In an alternate embodiment, the secure encryptor module 941 and the secure data source 944 may be located within the core application server or another secure remote resource. Other secure resources may also be possible, including depositories, supervisor switches, communication ports, removable storage media devices, biometric sensors, and other devices. In a preferred embodiment, the secure resources module 940 may include drivers and system configurations for providing access to the secure resources only from a secure controller module, such as a financial devices driver in the core application in the core application server 920.

The browser module 950 includes several modules related to security of the terminal 930 and transactions through it. The browser module 950 may be a portion of an interface application. The browser module 950 includes a certificate checking module 951, a locked configuration module 952, and an encryption module 953. The certificate checking module may verify the identity of any interface documents and objects therein prior to processing them. The locked configuration module 952 may include settings within the browser that may limit the sources and types of interface documents, applets, plug-ins, security protocols, and other data the browser will accommodate. The locked configuration module 952 includes a method of limiting access to the browser configuration once it has been properly configured for a financial services terminal. The encryption module 953 may be substantially similar to the encryption module 924 described above with regard to the core application server 920.

FIG. 10 shows an example method of providing secure financial transactions through a plurality of financial services terminals. In step 1001, the interface application in the financial services terminal is locked to prevent alteration of security settings. In step 1010, the interface application accesses restricted communication channels for the purpose of communicating with a secure data source. In step 1020, one or more secure interface documents are accessed within the secure data source. In step 1030, a certificate associated with the accessed interface document is verified by the interface application. In step 1040, a component request is encrypted and communicated from the interface application to a remote core application. In step 1050, a certificate associated with the component request is verified by the core application. In step 1060, the core application communicates with one or more secure resources in the financial services terminal in order to perform a portion of the component request transaction. In step 1070, secure communications, including appropriate encryption, format, and protocols, with a switch system are provided by the core application to perform a portion of the component request transaction. In step 1080, the core application returns an encrypted application response based upon the component request. In step 1090, the application response is verified based upon an associated certificate.

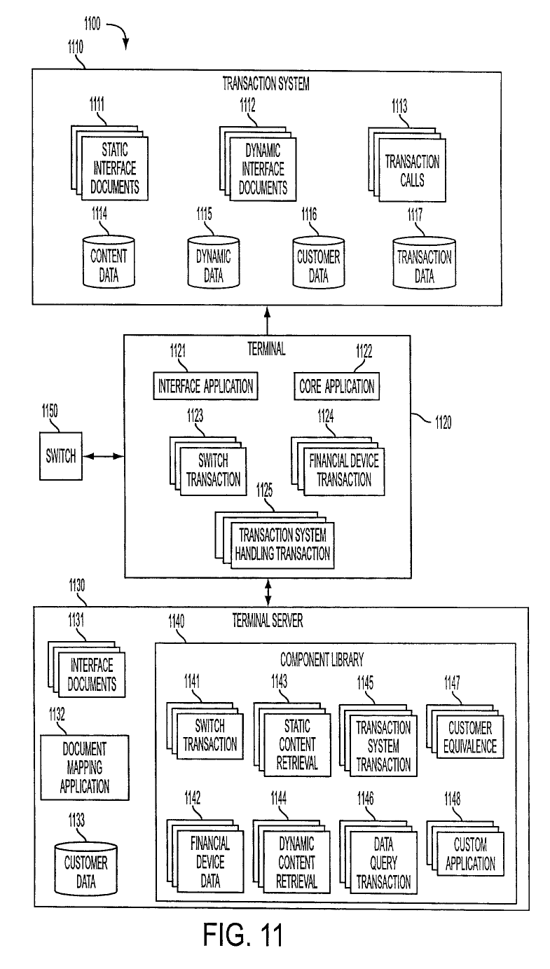

FIG. 11 shows an example system 1100 for integrating a transaction system with a plurality of financial services terminals. The system 1100 includes a transaction system 1110, a terminal 1120, a terminal server 1130, and a switch system 1150. The transaction system 1110 is connected to terminal 1120 by a communications network. In one embodiment, the communications network is the Internet. In an alternate embodiment, the communications network is a host institution intranet. The terminal 1120 is in communication with the terminal server 1130 and the switch system 1150. The terminal server 1130 may communicate with a plurality of terminals, including the terminal 1120, for providing centralized resources for the terminals. The terminal 1120 may communicate with the terminal server 1130 by a communications network, such as the Internet. In a preferred embodiment, the terminal 1120 and the terminal server 1130 are part of a host institution intranet. The switch system 1150 may communicate with the terminal 1120 over a communications network, such as a financial data network.

The transaction system 1110 may be any system remote from the terminal 1120 for providing a portion of the transaction processing for transactions such as financial transactions, information transactions, electronic commerce transactions, and other transactions. In one embodiment, the transaction system 1110 is at least a portion of a consumer oriented system offering transactions over the Internet, such as a consumer Web site. The transaction system may include a variety of resources that may be accessed by the terminal 1120 to provide at least a portion of the processing or data for one or more transactions through the terminal 1120. These resources may define one or more transaction applications. The transaction system 1110 includes a plurality of static interface documents 1111, a plurality of dynamic interface documents 1112, and a plurality of transaction calls 1113. The transaction system 1110 also includes a content data source 1114, a dynamic data source 1115, a customer data source 1116, and a transaction data source 1117.

The static interface documents 1111, the dynamic interface documents 1112, and the transaction calls 1113 may represent portions of a set of interface documents for providing one or more consumer services over the Internet. The static interface documents 1111 may include interface documents with fixed content. For example, the static interface documents 1111 may include simple HTML documents defined with particular text, graphics, sound, animations, frames, layout, and other features. The features are provided at a set location (e.g., IP address) and are substantially unchanged regardless of time or viewer. Minor variation may exist due to variations in layout, sizing, and other features, such as due to standard HTML methods for justifying display on the browser window size and variable browser settings being used to view the page. The dynamic interface documents 1112 may include interface documents that include customized content based upon one or more variables in an address, cookie, or other passive input source. For example, the dynamic interface documents 1112 may include Web pages that provide personalized content based upon user identification, regional identification, context identification, or other methods. The dynamic interface documents 1112 may include content that varies with time in a static location. The transaction calls 1113 may include a variety of methods for accessing transactional functions underlying the operation of a Web site or similar system. For example, the transaction calls 1113 may be based upon supplying data in a particular configuration, such as correlating to fields in an form HTML document. The transaction calls 1113 may be returned as HTML documents including static or dynamic content. In one embodiment, transaction calls 1113 may include direct access to a backend transaction processing application.

The content data source 1114, the dynamic data source 1115, the customer data source 1116, and the transaction data source 1117 may include one or more data libraries supporting the transaction applications and the interface documents. The content data source 1114 may include graphics, text, sound, animation, templates, entire documents, and other objects for providing content to the interface documents. In one embodiment, the objects in the content data source have a known location and are referenced directly according to their location. The dynamic data source 1115 is a very large data source with an associated data management structure for locating and retrieving data. For example, the dynamic data source may be a database with an associated query engine for locating desired content. The customer data source 1116 and the transaction data source 1117 may be instances of a dynamic data source or portions thereof directed to specific information. The customer data source 1116 and transaction data source 1117 may receive data from the transaction applications or interface documents, in addition to providing data to them.

The terminal 1120 may include a variety of applications and associated modules for providing transactions through the financial services terminals. The terminal 1120 includes an interface application 1121 and a core application 1122. Additional details regarding example interface applications and core applications are provided above with regard to FIGS. 110. There are a plurality of transaction modules associated with the core application 1122 for overseeing operation user transactions through the financial services terminal. Multiple transaction modules may be utilized in concert to complete a single user transaction or session. The transactions include a plurality of switch transaction modules 1123, a plurality of financial device transaction modules 1124, and a plurality of transaction system handling transaction modules 1125. The switch transaction modules 1123 may include transaction that rely on the switch system 1150 for at least a portion of their processing. The financial device transaction modules 1124 may include transactions that rely on information received from a secure financial device. The transaction system handling transaction modules 1125 may include modules for overseeing the exchange of data between the interface application 1121 and the transaction system 1110.

The terminal server 1130 includes a variety of resources for providing financial transactions through the terminal 1120 by accessing resources maintained by the transaction system 1110. The terminal server 1130 includes a plurality of interface documents 1131, a document mapping application 1132, customer data source 1133, and a component library 1140. The interface documents 1131 provide at least one set of documents for defining an interface, including display elements and transaction flow, for the terminal 1120. The document mapping application 1132 is an application for dynamically mapping data retrieved from interface documents or data sources in the transaction system 1110 to the interface documents 1131 for presentation through the terminal 1120. The customer data source 1133 may provide a variety of customer related information associated with one or more customer devices, such as cards, smart cards, or personal communication devices, for accessing the financial services terminal. In one embodiment, identification or account information associated with the customer devices is linked to personal information and account information for the transaction system 1110.

The component library 1140 may include a variety of components associated with one or more of then interface documents. The components define an input for providing user selection of a transaction function and input of the requisite data. Each component may include a method call to a transaction module in the core application for monitoring transactions placed through the terminal 1120. Each component may also include a method call to a resource, such as the transaction system 1110, the core application 1124, the document mapping application 1132, the customer data 1133, the switch system 1150, or some combination thereof, for completing at least a portion of the transaction processing for the transaction function associated with the component. The component library 1140 includes a plurality of switch transaction components 1141, a plurality of financial device data components 1142, a plurality of static content retrieval components 1143, a plurality of dynamic content retrieval components 1144, a plurality of transaction system transaction components 1145, a plurality of data query transaction components 1146, a plurality of customer equivalence components 1147, a plurality of customer application components 1148. The switch transaction components 1141 may include components for initiating a transaction function that is routed through the core application to the switch system 1150, such as withdrawal, deposit, balance inquiry, and other common ATM transactions. The financial device data components 1142 are components for initiating a portion of a transaction function requiring information from a financial device, such as a card reader or encryptor. The static content retrieval components 1143 are components for initiating a portion of a transaction function for retrieving static content, such as an advertisement, product information, news, or other information, from the transaction system 1110. The dynamic content retrieval component 1144 are components for retrieving dynamic content, such as information based on the users location, identity, or other pre-selected input, from the transaction system 1110. The transaction system transaction components 1145 are components for initiating a transaction function involving a transaction call, such as a search, data submission, or purchase transactions, to the transaction system 1110. The data query transaction components 1146 are components for initiating a transaction function for retrieving data directly from a data management system, such as the dynamic data source 1115, the customer data source 1116, or the transaction data source 1117. The customer equivalence components 1147 are components for initiating a portion of a transaction function involving customer information associated with a user device at the financial services terminal. The custom application components 1148 are components for initiating a transaction function involving an application in the terminal server 1130, such the document mapping application 1132.

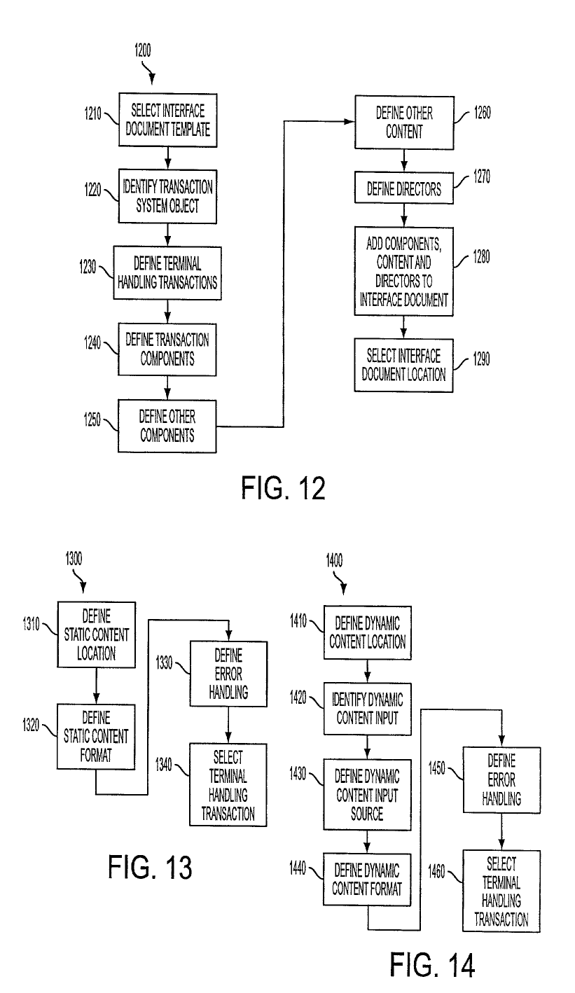

FIG. 12 shows an example method of integrating a transaction system with a plurality of financial services terminals through one or more interface documents and an interface application. In step 1210, an interface document template is selected for use in creating an interface document. In step 1220, at least one transaction system object associated with the transaction system is identified. In step 1230, one or more terminal handling transactions for monitoring the data exchange between the transaction system and the interface application is defined. In step 1240, one or more transaction components are defined for accessing the transaction system object and the terminal handling transactions from an interface application in each of the plurality of financial services terminals. In step 1250, one or more other components are defined for accessing other system resources, such as financial devices, customer data, document mapping applications, etc. In step 1260, other content is defined for display on the financial service terminals through the interface application and interface document. In step 1270, one or more directors are defined for providing relationships among interface documents. In step 1280, one or more defined components, content, and directors are added to the interface document. In step 1290, a location is defined for finding and linking to the interface document.

FIG. 13 shows an example method of defining a static content retrieval component after a static content object has been identified in a transaction system. In step 1310, a location of the static content object is defined for the static content retrieval component. In step 1320, a format of the static content object is defined for the static content retrieval component. In step 1330, error handling for communications with the transaction system are defined for the static content retrieval component. In step 1340, a terminal handling transaction is selected for overseeing execution of the static content retrieval component.

FIG. 14 shows an example method of defining a dynamic content retrieval component after a dynamic content object has been identified in a transaction system. In step 1410, a location of the dynamic content object is defined for the dynamic content retrieval component. In step 1420, one or more variable inputs for the dynamic content object are identified for the dynamic content retrieval component. In step 1430, one or more input sources are defined for the dynamic content server retrieval component to meet the input needs of the dynamic content object. In step 1440, a format of the dynamic content object is defined for the dynamic content retrieval component. In step 1450, error handling for communications between the interface application and the transaction system are defined for the dynamic content retrieval component. In step 1460, a terminal handling transaction is selected for monitoring the execution of the dynamic content retrieval component.

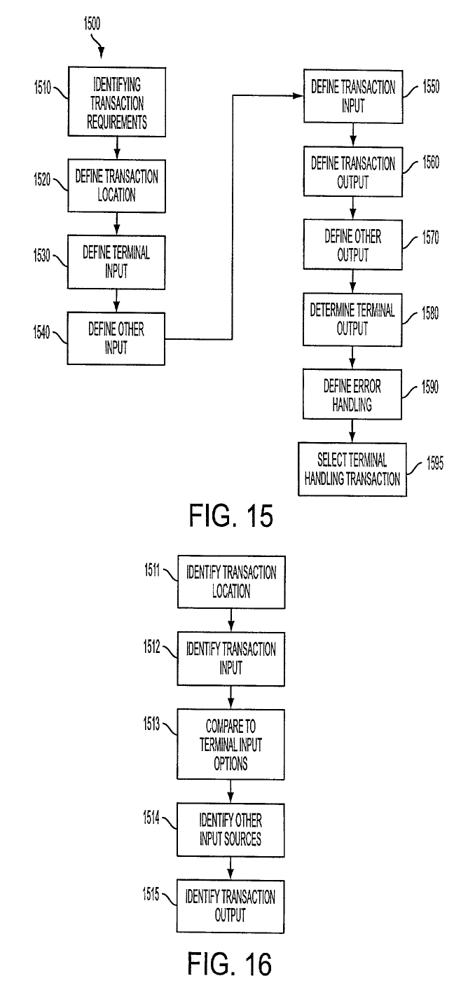

FIG. 15 shows an example method of defining a transaction system transaction component after a transaction call object has been identified in a transaction system. In step 1510, one or more transaction requirements are identified from the transaction call object. In step 1520, a location of the transaction call object is defined for the transaction system transaction component. In step 1530, one or more variable inputs to be fulfilled by data from a financial services terminal at runtime are defined for the transaction system transaction component. In step 1540, one or more inputs to be fulfilled by data from other system resources are defined for the transaction system transaction component. For example, data may be retrieved from a financial device, a local application or data source, a switch system, or another resource. In step 1550, one or more variable inputs to the terminal call object to be provided by the transaction system transaction component are defined for the transaction server transaction component. In step 1560, one or more variable outputs from the terminal call object are defined for the transaction system transaction component. In step 1570, one or more outputs to other system resources from the transaction system transaction component are defined for the transaction server transaction component. In step 1580, one or more outputs to the financial services terminal are defined for the transaction server transaction component.

FIG. 16 shows an example method of identifying transaction requirements for a transaction call object. In step 1511, a location of the transaction call object is identified.

In step 1512, one or more transaction inputs for the transaction call object are identified. In step 1513, the information types for fulfilling the identified transaction inputs are compared to one or more available input options through a financial services terminal of a selected terminal configuration. In step 1514, information types available from other sources are identified for potential use as input to the transaction call object. In step 1515, one or more transaction outputs for the transaction call object are identified. For example, a purchase transaction object may require a purchase item, a payment method, a shipping method, and a shipping location to be identified. A particular ATM configuration may include only a number pad, eight function keys, and a card reader. The system may also include a customer data source including a shipping address associated with the user's ATM card. An administrator identifying the transaction requirements might determine that the purchase item will have to have been previously selected (such as through an advertisement or prior search transactions) and saved within the session data of the financial services terminal, the payment method may be provided by the account information in the ATM card, the shipping method options may be associated with two of the function keys, and the shipping address may be retrieved from the customer data.

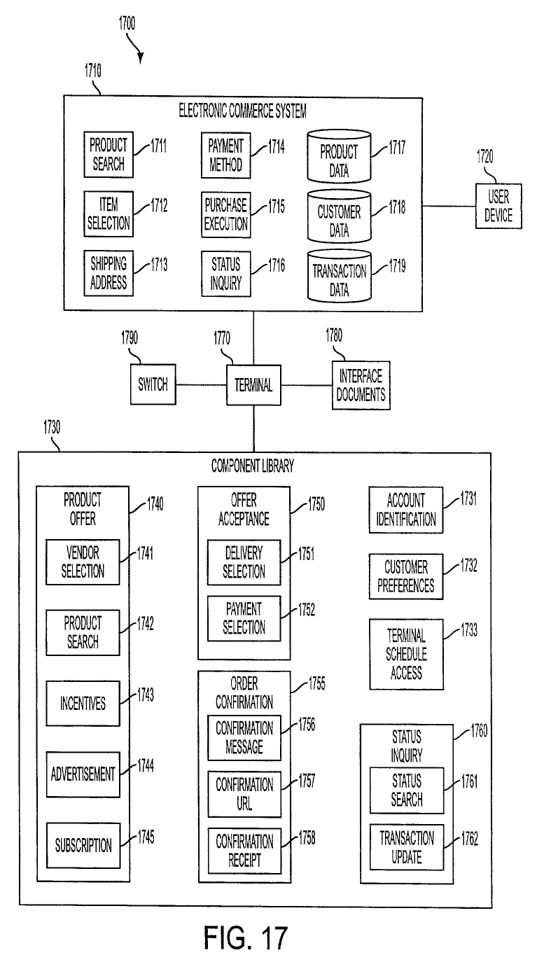

FIG. 17 shows an example system 1700 for integrating a electronic commerce system with a plurality of financial services terminals. The system 1700 includes an electronic commerce system 1710, a user device 1720, a component library 1730, a terminal 1770, a plurality of interface documents 1780, and a switch system 1780.

The electronic commerce system 1710 includes a variety of transaction modules that may include one or more transaction objects for providing transaction functions through the terminal 1770. The electronic commerce system 1710 includes a product search module 1711, an item selection module 1712, a Shipping Address module 1713, a payment method module 1714, a purchase execution module 1715, and a status inquiry module 1716. The electronic commerce system may include a variety of data sources for providing query transactions and static or dynamic content through the terminal 1770. The electronic commerce system 1710 includes a product data source 1717, a customer data source 1718, and a transaction data source 1719.

The component library 1730 includes a variety of components for providing an interface to the transaction functions of the electronic commerce system 1710 through the terminal 1770. The component library includes a number of product offer components 1740, a number of offer acceptance components 1750, a number of order confirmation components 1755, and a number of status inquiry components 1760. The terminal server 1730 also includes an account identification module 1731, a customer preferences module 1732, and a terminal schedule access module 1733. The modules shown are merely examples of some of the modules that may be employed by one or more components in order to access other system resources for the execution of transaction functions. The product offer components 1740 include a vendor selection component 1741, a product search component 1742, an incentives component 1743, an advertisement component 1744, and a subscription component 1745. The offer acceptance components 1750 include a delivery selection component 1751 and a Payment Selection component 1752. The order confirmation components 1755 includes a confirmation Message component 1756, a confirmation URL component 1757, and a confirmation Receipt component 1758. The status inquiry components 1760 includes a Status Search component 1761 and a Transaction Update component 1762.

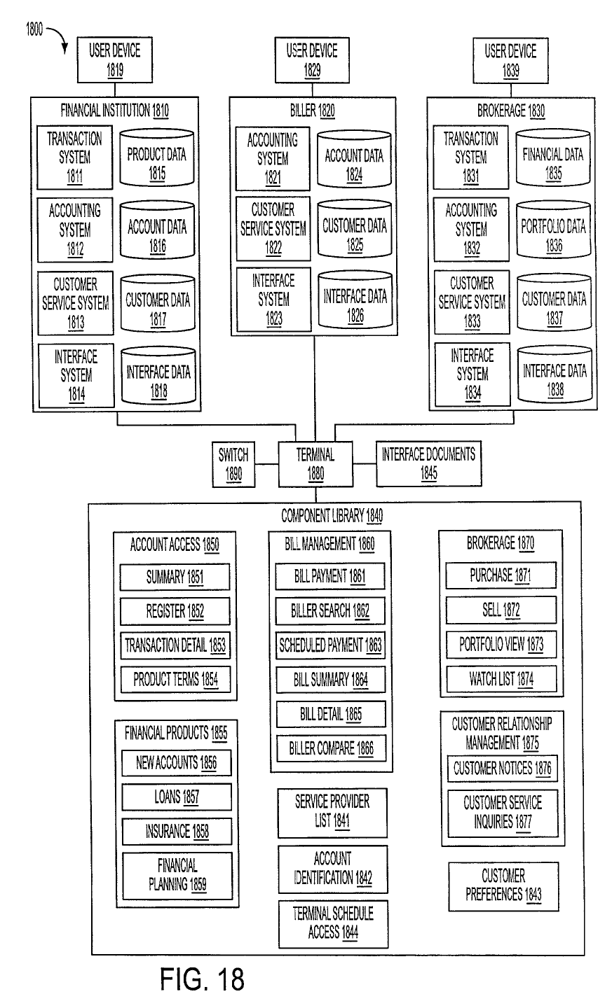

FIG. 18 shows an example system 1800 for integrating one or more financial systems with a number of financial services terminals. The system 1800 includes a number of financial systems, including a financial institution financial system 1810, a biller financial system 1820, and a brokerage financial system 1830. The number of financial systems of the system 1800 are accessible from a plurality of user devices 1819, 1829, and 1839. The system 1800 includes a component library 1840, a plurality of interface documents 1845, a terminal 1880, and a switch system 1890.

The financial institution financial system 1810 includes a transaction system 1811, an accounting system 1812, a customer service system 1813, and an interface system 1814. The financial institution financial system 1810 also includes a product data source 1815, an account data source 1816, a customer data source 1817, and an interface data source 1818.

The biller financial system 1820 includes an accounting system 1821, a customer service system 1822, and an interface system 1823. The biller financial system 1820 includes a product data source 1824, a customer data source 1825, and an interface data source 1826.

The brokerage financial system 1830 includes a transaction system 1831, an accounting system 1832, a customer service system 1833, and an interface system 1834. The brokerage financial system 1830 also includes a financial data source 1835, a portfolio data source 1836, a customer data source 1837, and an interface data source 1838.

The component library 1840 includes a number of account access components 1850, a number of financial products components 1855, a number of bill management components 1860, a number of brokerage components 1870, and a number of customer relationship management components 1875. The component library 1840 also includes a service provider list module 1841, an account identification module 1842, a customer preferences module 1843, and a function access schedule 1844.

The account access components 1850 include a Summary component 1851, a register component 1852, a transaction detail component 1853, and a product terms component 1854.

The number of Financial Products components 1855 include a new accounts component 1856, a loans component 1857, an insurance component 1858, and a financial planning component 1859.

The bill management components 1860 include a bill payment component 1861, a biller search component 1862, a scheduled payment component 1863, a bill summary component 1864, a bill detail component 1865, and a biller compare component 1866.

The brokerage components 1870 include a purchase component 1871, a sell component 1872, a portfolio view component 1873, and a watch list component 1874.

The customer relationship Management components 1875 include a Customer Notices component 1876 and a Customer Service Inquiry component 1877.

This invention has been described in connection with the preferred embodiments. These embodiments are intended to be illustrative only. It will be readily appreciated by those skilled in the art that modifications may be made to these preferred embodiments without departing from the scope of the invention as defined by the appended claims.

What is claimed is:

1. A system for supervising a plurality of remote financial services terminals, comprising:
an interface application within each of the plurality of remote financial service terminals for displaying a plurality of interface documents with a plurality of components for accessing financial transactions;
a core application in communication with the interface application, the core application overseeing processing of a plurality of financial transactions accessed through the components in the plurality of interface documents; and
a supervisor application in communication with the core application for performing a plurality of administrative functions for overseeing the operation of the plurality of remote financial service terminals.

2. The system of claim 1, wherein the plurality of components include at least one supervisor component, the at least one supervisor component communicating with the supervisor application when an interface document from among the plurality of interface documents including the at least one supervisor component is loaded by the interface application.

3. The system of claim 1, wherein the core application includes a plurality of supervisor transactions and wherein the supervisor application includes a plurality of method calls for accessing the plurality of supervisor transactions for performing at least a portion of the plurality of administrative functions.

4. The system of claim 1, wherein the supervisor application includes a remote diagnostic module in communication with the core application for initiating operation of a supervisor transaction that provides diagnostic information regarding at least one device, module, or function in at least one of the plurality of financial services terminals associated with the core application.

5. The system of claim 1, wherein the supervisor application includes a log access module in communication with the core application for initiating a supervisor transaction that provides access to log information in at least one of the plurality of financial services terminals associated with the core application.

6. The system of claim 1, wherein the supervisor application includes a metric aggregation module in communication with the interface application for receiving and storing usage information from the plurality of financial services terminals.

7. The system of claim 6, wherein the plurality of interface documents include at least one supervisor component for sending usage information from the plurality of financial services terminals to the metric aggregation module.

8. The system of claim 1, wherein the interface application selectively displays a plurality of supervisor interface documents for providing a local administrator interface for the plurality of financial services terminals.

9. The system of claim 8, wherein a message is communicated to the supervisor application when the plurality of supervisor interface documents are accessed.

10. The system of claim 8, wherein the plurality of supervisor interface documents include at least one supervisor component for sending administrator usage information from the plurality of financial services terminals to the supervisor application.

11. The system of claim 1, further comprising an interface document data source including at least a portion of the plurality of interface documents and wherein the supervisor application includes an interface document editor for accessing and modifying the plurality of interface documents.

12. The system of claim 1, further comprising an object library data source including the plurality of components and wherein the supervisor application includes an object library editor for accessing and modifying the plurality of components.

13. The system of claim 1, wherein the supervisor application includes a core module editor for accessing and modifying the core application.

14. The system of claim 13, wherein the core application includes a plurality of transaction modules associated with overseeing the plurality of financial transactions and the core module editor delivers at least one new transaction module to a plurality of core applications.

15. A method of providing supervision of a plurality of financial services terminals including the steps of:
providing a plurality of financial services terminals in locations remote from a supervisor application, the plurality of financial services terminals including an interface application for displaying a plurality of interface documents;
providing a core application in communication with the plurality of financial services terminals, the core application including a plurality of modules for overseeing operation of the plurality of financial services terminals;
communicating a method call from the supervisor application to the core application;
initiating at least one of the plurality of modules for an administrative function in response to the method call communicated from the supervisor application; and
receiving a method response from the core application in the supervisor application.

16. The method of claim 15, wherein the plurality of interface documents include at least one supervisor component and further comprising the step of communicating data from the interface application to the supervisor application in response to executing the at least one supervisor component.

17. The method of claim 16, further comprising the steps of:
providing a metric aggregation module remote from the plurality of financial services terminals;
communicating usage data from the interface application to the metric aggregation module; and
aggregating the usage data from the plurality of financial services terminals.

18. The method of claim 15, wherein the plurality of modules includes at least one supervisor transaction module and wherein the step of initiating at least one of the plurality of modules includes initiating the at least one supervisor transaction module.

19. The method of claim 18, wherein the at least one supervisor transaction module is a diagnostic transaction module and further comprising the steps of:
providing a remote diagnostics module remote from the plurality of financial services terminals; and
communicating diagnostic data from the core application to the remote diagnostics module in response to executing the diagnostic transaction module.

20. The method of claim 18, wherein the at least one supervisor transaction module is a log access transaction module and further comprising the steps of:
providing a remote log access module remote from the plurality of financial services terminals; and
communicating log data from the core application to the remote log access module in response to executing the log access transaction module.

21. The method of claim 15, further comprising the steps of:
providing a plurality of supervisor interface documents accessible to the plurality of financial services terminals;
locally accessing the plurality of supervisor interface documents through the plurality of financial services terminals; and
communicating data in response to local access of the plurality of supervisor interface documents to the supervisor application.

22. A system of providing remote aggregation of data from a plurality of financial services terminal comprising:
a plurality of interface documents accessible to the plurality of financial services terminals for displaying an interface for a plurality of financial transactions;
at least one component for listening for at least one event at the plurality of financial services terminals;
a remote metric aggregation module for receiving and storing usage data from the plurality of financial services terminals in response to the occurrence of the at least one event at the plurality of financial services terminals.

23. The system of claim 22, wherein the at least one event includes loading an interface document from among the plurality of interface documents including the at least one component and the usage data communicated to the remote metric aggregation module includes an identifier for the interface document.

24. The system of claim 22, wherein the at least one event includes input from a user of the plurality of financial services terminals and the usage data includes at least a portion of the input from the user.

25. The system of claim 22, further comprising a core application for overseeing execution of the plurality of financial transactions and wherein the component includes a method call to the core application for reporting communications to the remote metric aggregation module.

26. A system for providing local administration of a plurality of financial services terminals comprising:
a plurality of consumer interface documents for displaying an interface for a plurality of financial transactions through the plurality of financial services terminals;
a plurality of supervisor interface documents for displaying an interface for a plurality of administrative functions through the plurality of financial services terminals; and
a remote supervisor application in communication with the plurality of financial services terminals for monitoring access to the plurality of administrative functions.

27. The system of claim 26, further comprising a core application including a plurality of supervisor transaction modules and wherein the plurality of supervisor interface documents include a plurality of components for accessing the plurality of supervisor transaction modules.

28. The system of claim 26, wherein the plurality of financial services terminals include a supervisor switch for accessing the plurality of supervisor interface documents.

29. The system of claim 26, wherein the remote supervisor application validates the identity of a user prior to enabling access to the plurality of administrative functions.

30. The system of claim 26, wherein the plurality of administrative functions include access to a cash dispenser, a card reader, a depository, a removable storage media device, a printer, a supervisor transaction module, a transaction log module, a system configuration module, an interface application configuration module, or a core application configuration module.

31. A system for supervising a plurality of financial services terminals including an interface application, comprising:
a plurality of interface documents accessible to the plurality of financial services terminals for providing an interface for a plurality of financial transactions through the interface application;
an object library accessible to the plurality of financial services terminals, the object library including a plurality of objects associated with the plurality of interface documents for providing content and functionality to the plurality of interface documents;
a supervisor application associated with the object library and the plurality of interface documents for managing the object library and the plurality of interface documents.

32. The system of claim 31, wherein the plurality of objects in the object library include a plurality of directors, a plurality of components, and a plurality of content objects for use in the plurality of interface documents.

33. The system of claim 31, wherein the supervisor application includes an interface document editor for creating, adding, modifying, or deleting an interface document selected from among the plurality of interface documents.

34. The system of claim 33, wherein the object library includes a plurality of interface templates for creating interface documents for addition to the plurality of interface documents.

35. The system of claim 31, wherein the supervisor application includes an object library editor for creating, adding, modifying, or deleting an object from among the plurality of objects in the object library.

36. The system of claim 35, wherein the object library includes a plurality of object templates for creating objects for addition to the object library.

37. The system of claim 36, wherein the plurality of object templates are predefined with at least one method call to a transaction module in a core application associated with the plurality of financial services terminals.

38. The system of claim 31, further comprising a core application associated with the plurality of financial services terminal and including a plurality of transaction modules for enabling the plurality of financial transactions through the plurality of financial services terminals, the plurality of transaction modules accessed by method calls in a plurality of components within the object library.

39. The system of claim 38, further comprising a core module editor for remotely creating, adding, modifying, or deleting a transaction module selected from the plurality of transaction modules in the core application.

40. A method of customizing a plurality of interface documents for use by a plurality of financial services terminals including the steps of:
selecting an interface document template from an object library to initiate creation of a custom interface document;
selecting at least one director from the object library;
adding the selected at least one director to the custom interface document for defining a relationship to at least one other interface document;
selecting at least one component from the object library; and
adding the selected at least one component to the custom interface document for defining access to at least a portion of a financial transaction.

41. The method of claim 40, further comprising the steps of:
selecting at least one content object from an object library; and
adding the selected content object to the custom interface document for defining added content for display in the custom interface document.
